(19) United States
(12) Patent Application Publication
(10) Pub. No.: US 2008/0045325 A1
(43) Pub. Date: Feb. 21, 2008

(54) Slot machine and playing method thereof

(75) Inventor: Yoichi Kato, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/892,075

(22) Filed: Aug. 20, 2007

(30) Foreign Application Priority Data
Aug. 21, 2006 (JP) JP2006-224141

(51) Int. Cl. A63F 13/00

(52) U.S. Cl. 463/21

(57) ABSTRACT

When a plurality of symbols is rearranged on a display as new symbols, if there exist a prescribed number or more of neighboring symbols having the same attribute, an award is provided and at the same time, the prescribed number or more of neighboring symbols are deleted, and the neighboring symbols arranged as the symbol matrix are shifted in a prescribed direction to be rearranged in the vacant areas from which the symbols have been deleted. When a prescribed number or more of symbols having the same attribute come adjacent to one another again, an award is provided further.

### CROSS REFERENCE TO RELATED APPLICATION

This application is based upon and claims the benefit of priority from Japanese Patent Application No. 2006-224141 filed on Aug. 21, 2006, the entire contents of which are incorporated herein by reference.

### BACKGROUND OF THE INVENTION

1. Field of the Invention

The present invention relates to a slot machine to play a game using a game medium, such as coin and bill, and a playing method thereof.

2. Description of the Related Art

According to a convention slot machine disclosed in U.S. Pat. No. 6,960,133 or U.S. Pat. No. 6,012,983, when a player inserts a game medium, such as medal, coin, bill, etc., into an insertion slot of a slot machine and presses a spin button, a plurality of symbols displayed on a display part provided on the front of the case is scrolled and then, each symbol automatically stops. In such an action, the processing to determine stop symbols has been performed when the spin button is pressed. When a transition to a bonus game, such as mystery bonus, second game, etc., is won due to the processing to determine stop symbols, the game transits from the base game to the bonus game and the bonus game is executed. Then, the slot machine is set so as to make a payout in accordance with a winning state that occurs as the game progresses.

Conventionally, an activated line (also referred to as a payline) to determine a combination of stop symbols is in general a straight line on a plurality of mechanical reels or video reels displayed on a liquid crystal display device. Recently, however, in addition to such a straight activated line, a slot machine appears that has taken into consideration a variety of activated lines as shown below. U.S. Pat. No. 6,093,102 and U.S. Pat. No. 6,960,133 have disclosed a slot machine that also includes activated lines other than the straight line.

In the above-mentioned slot machine, when a certain symbol stops on the activated line set on the matrix display part consisting of a plurality of columns and rows, a payout is made. As a result, the above-mentioned slot machine has the same display style as that of a slot machine having the previous straight activated line in that a combination of symbols accompanied by payout is formed on a prescribed line.

### SUMMARY OF THE INVENTION

An object of the present invention is to provide a slot machine and a playing method thereof capable of providing a player with a sense of high expectation by giving novel entertainment property.

A first aspect of the present invention is a slot machine, comprising: a display on which display areas are formed in a matrix form, the display areas scrolling symbol columns in which a plurality of symbols having mutually different attributes is arranged, and which arranges a symbol matrix of symbols displayed in each of the display areas when the scroll stops; and a controller operable to: after scrolling the symbol columns arranged on the display in one direction, in order to rearrange them as a new symbol matrix, (a) select and determine symbols arranged in the symbol matrix from among the plurality of symbols having the different attributes and (b) stop scroll state with the determined symbols; when the symbols are arranged on the display and if there exist a prescribed number or more of neighboring symbols having the same attribute, (c) delete the prescribed number or more of neighboring symbols and (d) shift the symbols arranged as the symbol matrix in a prescribed direction to rearrange them in the vacant areas from which the symbols have been deleted; and when the prescribed number or more of neighboring symbols form a combination accompanied by an award, and/or when the symbols rearranged as the symbol matrix form a combination accompanied by the award, (e) provide the award in accordance with each combination.

According to the above-mentioned slot machine, when the plurality of symbols are rearranged by new symbols and if there exist a prescribed number or more of neighboring symbols having the same attribute, the prescribed number or more of neighboring symbols are deleted. The undeleted symbols arranged as the symbol matrix are shifted in a prescribed direction and thereby rearranged in the vacant areas where the symbols have been deleted. Then, when a combination accompanied by an award is achieved by the prescribed number or more of neighboring symbols having the same attribute, the award is provided and when a combination accompanied by an award is achieved by the rearranged symbols, the award is provided further.

A second aspect of the present invention is a slot machine, comprising: a display on which display areas are formed in a matrix form, the display areas scrolling symbol columns including a plurality of arranged symbols having mutually different attributes, and which arranges a symbol matrix of symbols stopped and displayed in each of the display areas; a memory configured to store a combination accompanied by an award and the award corresponding to the combination; and a controller operable to: after scrolling the symbol columns arranged on the display in one direction, in order to rearrange them as a new symbol matrix, (a) select and determine symbols to be arranged in the symbol matrix from among the plurality of symbols having different attributes and (b) stop scroll state with the determined symbols; when the symbols are arranged on the display and if there exist a prescribed number or more of neighboring symbols having the same attribute, (c) delete the prescribed number or more of neighboring symbols and (d) shift the undeleted symbols arranged as the symbol matrix in a prescribed direction to vacant areas where the symbols have been deleted; (e) determine whether the symbols stopped and the symbols rearranged as the symbol matrix form the combination accompanied by the award stored in the memory; and when the prescribed number or more of neighboring symbols form the combination accompanied by the award, and/or when the symbols rearranged as the symbol matrix form the combination accompanied by the award, (f) provide the award in accordance with each combination.

According to the above-mentioned slot machine, when the plurality of symbols are rearranged by new symbols and if there exist a prescribed number or more of neighboring symbols having the same attribute, the prescribed number or more of neighboring symbols are deleted and the undeleted symbols arranged as the symbol matrix are shifted in a prescribed direction and thereby rearranged in the vacant areas where the neighboring symbols have been deleted. Then, whether the symbols stopped and the symbols rearranged as the symbol matrix form a combination accompanied by an award stored in a memory is determined. When the combination accompanied by the award is achieved by the prescribed number or more of the neighboring symbols having the same attribute, and further, when the symbols successively form a combination accompanied by the award in the rearrangement, the award is provided in accordance with the combination.

A third aspect of the present invention is a slot machine, comprising: a display on which display areas are formed in a matrix form, the display areas scrolling symbol columns including a plurality of arranged symbols having mutually different attributes, and which arranges a symbol matrix of symbols stopped and displayed in each of the display areas; a memory configured to store the combination of the symbols accompanied by an award and the award corresponding to the combination; a counter configured to count, when the rearranged symbols successively form the combination accompanied by the award, the number of successive times the combination accompanied by the award is formed: and a controller operable to: after scrolling the symbol columns arranged on the display in one direction, in order to rearrange them as a new symbol matrix, (a) select and determine symbols to be arranged in the symbol matrix from among the plurality of symbols having the different attributes and (b) stop scroll state with the determined symbols; when the symbols are arranged on the display and if there exist a prescribed number or more of neighboring symbols having the same attribute, (c) delete the prescribed number or more of neighboring symbols and (d) shift the undeleted symbols arranged as the symbol matrix in a prescribed direction to vacant areas where the symbols have been deleted; (e) determine whether the symbols stopped and the symbols rearranged as the symbol matrix form the combination accompanied by the award stored in the memory; and when the symbols stopped and the symbols rearranged as the symbol matrix form the combination accompanied by the award and when the symbols successively form the combination accompanied by the award in the rearrangement, (f) provide the award in accordance with the combination and the number of successive times of the combination counted by the counter.

According to the above-mentioned slot machine, when the plurality of symbols are rearranged as new symbols and if there exist a prescribed number or more of neighboring symbols having the same attribute, the prescribed number or more of neighboring symbols are deleted and the undeleted symbols arranged as the symbol matrix are shifted in a prescribed direction and thereby rearranged in the vacant areas where the symbols have been deleted. Then, whether the symbols stopped by the controller and the symbols rearranged by the controller as the symbol matrix form a combination accompanied by an award stored in a memory configured to store the combination accompanied by the award and the award corresponding to the combination is determined. Further, the number of times the symbols successively form a combination accompanied by the award in the rearrangement is counted by the counter. Then, when a combination accompanied by the award is achieved by the prescribed number or more of neighboring symbols having the same attribute, and when the symbols successively form a combination accompanied by the award in the rearrangement, the award is provided in accordance with the combination and the number of successive times.

A fourth aspect of the present invention is a playing method of a slot machine, comprising: a first arrangement step of, in display areas arranged on a display in a matrix form and that scroll symbol columns including a plurality of arranged symbols having mutually different attributes, after scrolling the symbol columns in one direction, selecting and determining symbols to be arranged as the symbol matrix from among the plurality of symbols having the different attributes, stopping scroll state with the determined symbols, and rearranging them as a new symbol matrix;

a second arrangement step of, when the symbols are arranged on the display as the symbol matrix and if there exist a prescribed number or more of neighboring symbols having the same attribute, deleting the prescribed number or more of neighboring symbols and shifting the undeleted symbols arranged as the symbol matrix in a prescribed direction to vacant areas where the symbols have been deleted; and

an award step of, when the prescribed number or more of neighboring symbols form a combination in the first arrangement step, and/or when the symbols rearranged in the second arrangement step form a combination accompanied by an award, providing the award in accordance with each combination.

According to the above-mentioned playing method of a slot machine, when the plurality of symbols are rearranged as new symbols and if there exist a prescribed number or more of neighboring symbols having the same attribute, the prescribed number or more of neighboring symbols are deleted and the undeleted symbols arranged as the symbol matrix are shifted in a prescribed direction and thereby rearranged in vacant areas where the symbols have been deleted. Then, when a combination accompanied by an award is achieved by the prescribed number or more of neighboring symbols having the same attribute, the award is provided further.

A fifth aspect of the present invention is a playing method of a slot machine, comprising: a first arrangement step of, in display areas arranged on a display in a matrix form and that scroll symbol columns including a plurality of arranged symbols having mutually different attributes, after scrolling the symbol columns in one direction, selecting and determining symbols to be arranged as the symbol matrix from among the plurality of symbols having the different attributes, stopping scroll state with the determined symbols, and rearranging them as a new symbol matrix;

a second arrangement step of, when the symbols are arranged on the display and if there exist a prescribed number or more of neighboring symbols having the same attribute, deleting the prescribed number or more of neighboring symbols and shifting the undeleted symbols arranged as the symbol matrix in a prescribed direction to vacant areas where the symbols have been deleted;

a determination step of determining whether the symbols stopped in the first arrangement step and the symbols rearranged in the second arrangement step form a combination accompanied by an award stored in a memory configured to store the combination accompanied by the award and the award corresponding to the combination; and

an award step of, when the prescribed number or more of neighboring symbols form the combination accompanied by the award in the first arrangement step and/or when the symbols rearranged in the second arrangement step form the combination accompanied by the award, providing the award in accordance with each combination.

According to the above-mentioned slot machine, when the plurality of symbols are rearranged as new symbols and if there exist a prescribed number or more of neighboring symbols having the same attribute, the prescribed number or more of neighboring symbols are deleted and the undeleted symbols arranged as the symbol matrix are shifted in a prescribed direction and thereby rearranged in the vacant areas where the symbols have been deleted. Then, whether the symbols stopped in the first arrangement step and the symbols rearranged as the symbol matrix in the second arrangement step form a combination accompanied by an award stored in a memory is determined. When the combination accompanied by the award is achieved by the prescribed number or more of neighboring symbols having the same attribute, and further, when the symbols successively form a combination accompanied by the award in the rearrangement in the second arrangement step, the award is provided in accordance with the combination.

A sixth aspect of the present invention is a playing method of a slot machine, comprising: a first arrangement step of, in display areas arranged on a display in a matrix form and that scroll symbol columns including a plurality of arranged symbols having mutually different attributes, after scrolling the symbol columns in one direction, selecting and determining symbols to be arranged as the symbol matrix from among the plurality of symbols having different attributes, stopping scroll state with the determined symbols, and rearranging them as a new symbol matrix;

a second arrangement step of, when the symbols are arranged on the display and if there exist a prescribed number or more of neighboring symbols having the same attribute, deleting the prescribed number or more of neighboring symbols and shifting the undeleted symbols arranged as the symbol matrix in a prescribed direction to vacant areas where the symbols have been deleted;

a determination step of determining whether the symbols stopped in the first arrangement step and the symbols rearranged in the second arrangement step form a combination accompanied by an award stored in a memory configured to store the combination accompanied by the award and the award corresponding to the combination;

a count step of, when the symbols successively form the combination accompanied by the award by the rearrangement in the second arrangement step, counting the number of successive times the combination accompanied by the award is formed; and

an award step of, when it is determined in the determination step that the symbols stopped in the first arrangement step and the symbols rearranged in the second arrangement step form the combination accompanied by the award and it is determined that the symbols successively form the combination accompanied by the award by the rearrangement in the second arrangement step, providing the award in accordance with the combination and the number of successive times of the combination counted by the counter.

According to the above-mentioned slot machine, when the plurality of symbols are rearranged as new symbols and if there exist a prescribed number or more of neighboring symbols having the same attribute, the prescribed number or more of neighboring symbols are deleted and the undeleted symbols arranged as the symbol matrix are shifted in a prescribed direction, and thereby rearranged in the vacant areas where the symbols have been deleted. Then, whether the symbols stopped in the first arrangement step and the symbols rearranged as the symbol matrix in the second arrangement step form a combination accompanied by a award stored in a memory is determined. Further, the number of times the symbols successively form a combination accompanied by the award in the rearrangement in the second arrangement step is counted by the counter. Then, when the combination accompanied by the award is achieved by the prescribed number or more of neighboring symbols having the same attribute, and further, when the symbols successively form the combination accompanied by the award in the rearrangement in the second arrangement step, the award is provided in accordance with the combination and the number of successive times.

### BRIEF DESCRIPTION OF THE DRAWINGS

FIG. 1 is a flow chart showing a playing method of a slot machine according to an embodiment of the present invention.

FIG. 2 is a perspective view showing an outside appearance of a slot machine according to an embodiment of the present invention.

FIG. 3 is a diagram showing symbols and code numbers of the respective symbols displayed in respective display areas of a slot machine according to an embodiment of the present invention.

FIG. 4 is a diagram of a payout table showing a relationship between a winning combination and its payout in an embodiment of the present invention.

FIG. 5 is a diagram of a payout table showing a relationship between the number of linked symbols and its payout in an embodiment of the present invention.

FIG. 6 is a diagram of an odds table showing a relationship between the number of times of the chain reaction of combination and odds in an embodiment of the present invention.

FIG. 7 is a block diagram showing a control circuit of a slot machine according to an embodiment of the present invention.

FIG. 8 is a flow chart showing the procedure of authentication read processing of a game program and a game system program by a motherboard and a gaming board of a slot machine according to an embodiment of the present invention.

FIG. 9 is a flow chart showing the procedure of a basic game executed in a slot machine according to an embodiment of the present invention.

FIG. 10 is a flow chart showing the procedure of processing of a chain reaction game executed in a slot machine according to an embodiment of the present invention.

FIG. 11 is a flow chart showing the procedure of stop symbol determination processing executed in a slot machine according to an embodiment of the present invention.

FIG. 12 is a flow chart showing the procedure of symbol scroll processing executed in a slot machine according to an embodiment of the present invention.

FIG. 13 is a flow chart showing the procedure of processing of a bonus game executed in a slot machine according to an embodiment of the present invention.

FIG. 14 is an explanatory diagram showing a display example when a chain reaction game is executed in a slot machine according to an embodiment of the present invention.

FIG. 15 is an explanatory diagram showing a display example when a chain reaction game is executed in a slot machine according to an embodiment of the present invention.

FIG. 16 is an explanatory diagram showing a display example when a chain reaction game is executed in a slot machine according to an embodiment of the present invention.

FIG. 17 is an explanatory diagram showing a display example when a chain reaction game is executed in a slot machine according to an embodiment of the present invention.

FIG. 18 is an explanatory diagram showing a display example when a chain reaction game is executed in a slot machine according to an embodiment of the present invention.

FIG. 19 is an explanatory diagram showing a display example when a chain reaction game is executed in a slot machine according to an embodiment of the present invention.

FIG. 20 is an explanatory diagram showing a display example when a chain reaction game is executed in a slot machine according to an embodiment of the present invention.

FIG. 21 is an explanatory diagram showing a display example when a chain reaction game is executed in a slot machine according to an embodiment of the present invention.

FIG. 22 is an explanatory diagram showing a display example when a chain reaction game is executed in a slot machine according to an embodiment of the present invention.

### DETAILED DESCRIPTION OF THE EMBODIMENTS

A slot machine shown as an embodiment of the present invention will be described below in detail using drawings.

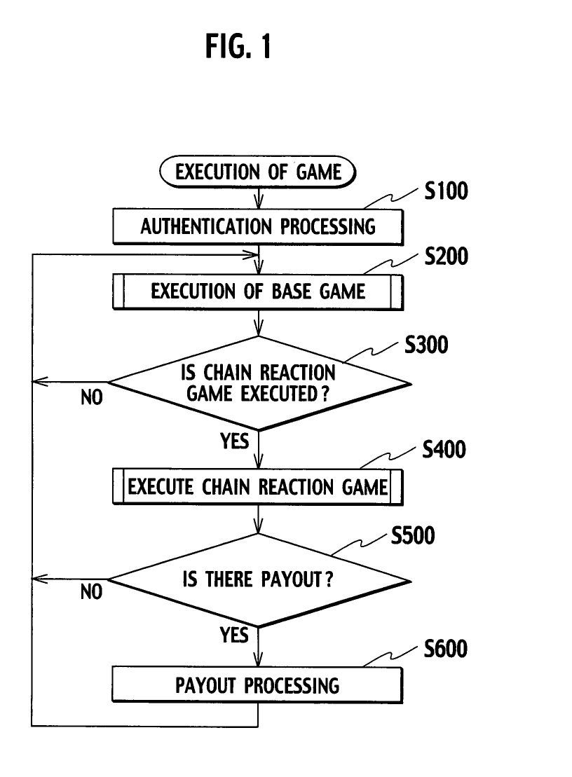

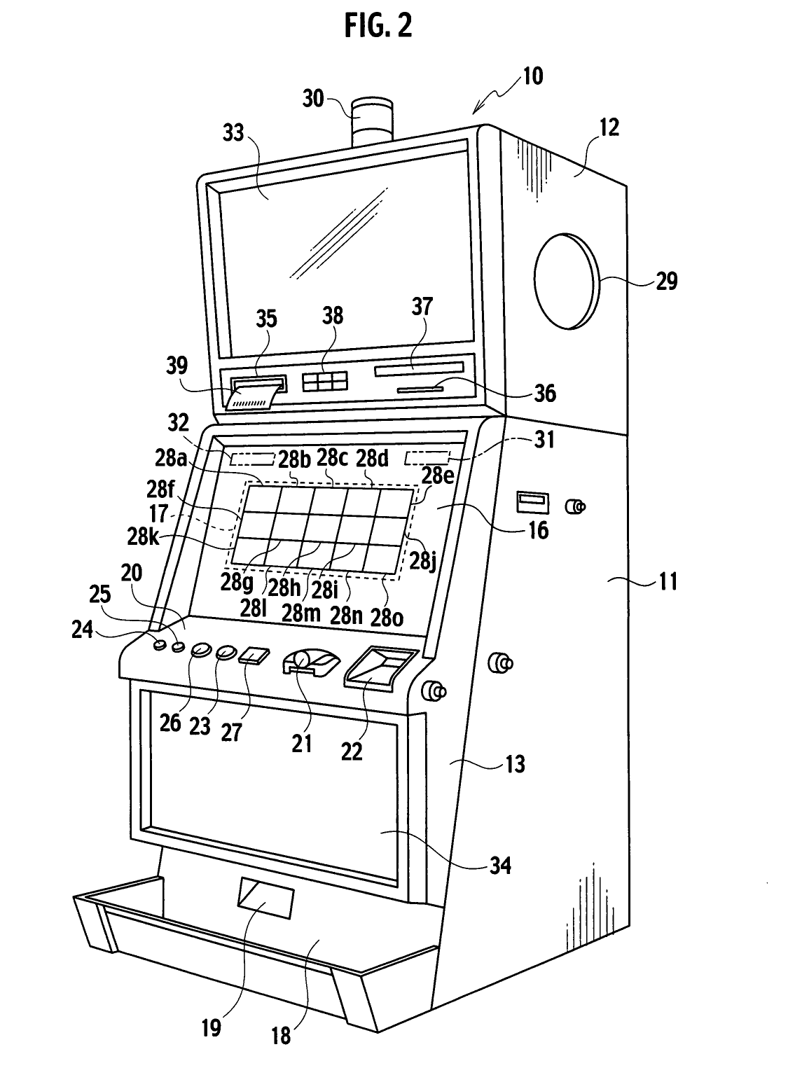

FIG. 1 is a flow chart schematically showing a playing method of a slot machine according to an embodiment of the present invention. FIG. 2 is a perspective view showing an outside appearance of a slot machine thereof.

In a slot machine according to an embodiment of the present invention, when power is supplied and the slot machine is activated, first, authentication processing is performed (step S100). In the authentication processing, initial checking processing is performed in the pre-stage before a unit game is started, such as to check whether or not programs to activate the system operate normally, to check whether or not falsification of the program has been carried out, etc.

Next, abase game is executed (step S200). When a spin button 23 is pressed in a state in which a desired number of credits have been bet by inserting a coin into a coin insertion slot 21 etc., the unit game is executed. In the unit game, in each of display areas (28a to 28o) of a liquid crystal display 17 provided on the front of a cabinet 11, scroll of a symbol column is started. Then, the scroll stops and symbols are stopped (rearranged) in each of the display areas 28 (28a to 28o) with 5×3 squares (15 in total).

In each unit game, processing is performed in order to determine symbols to be stopped in each of the display areas (28a to 28o) among a plurality of symbols having different attributes and arrangement control of stopping the determined symbols is carried out. In the present embodiment, the attribute is defined as a kind of a symbol.

In the present embodiment, when the scroll stops and symbols are displayed, the condition whether or not a payout (award) is made for the player is not determined based on whether or not a specific combination has been formed on a conventional “activated line” but determined when a combination of a prescribed number or more of neighboring symbols of the same kind (or same attribute) has been formed.

Then, in the present embodiment, in an arranged symbol matrix, when a prescribed number or more of symbols having the same attribute comes adjacent to one another, a payout (award) for the combination of symbols is calculated and at the same time, these symbols are deleted. Then, the processing to rearrange a symbol matrix is performed by shifting the symbols arranged as the symbol matrix in a prescribed direction (for example, in the longitudinal direction) to rearrange them in the display areas that have become vacant due to the deletion. Consequently, by repeating such a rearrangement, there is the possibility that another combination is achieved. In the present embodiment, for example, a state in which there exist a prescribed number or more of neighboring symbols of the same kind (same attribute) is called a “symbol link”. In addition, when a “symbol link” occurs again in a symbol matrix achieved by the rearrangement after the combination achieved by linked symbols has been deleted, and further, when a “symbol link” occurs successively for each rearrangement, it is called a “chain reaction of combination”. In the base game, a game that is started when a symbol link portion occurs as a trigger is called a chain reaction game.

The present embodiment is also characterized in that a payout (award) to a player is calculated by the operation of addition or multiplication in accordance with the finally achieved combination and the number of successive times of the chain reaction of combination. It may also be possible to determine in advance a combination of symbols to transit to a bonus game (bonus trigger) so that the game transits to the bonus game when the combination is achieved (steps S200, S300, S400).

When a chain reaction game is started, a symbol matrix is rearranged in each of the display areas 28 (28a to 28o). When the rearrangement is completed, and finally the above-described “symbol link” and “chain reaction of combination” do not occur any more (step S500), payout (award) processing is executed to make the payout based on a payout (award) table (step S600). The detail of each game described above will be described later.

In the present embodiment, an example has been described, in which a symbol column is displayed in each of the 15 display areas 28 (28a to 28o) with 5×3 squares. However, the present invention is not limited to the display areas 28 with 5×3 squares.

Next, a configuration of a slot machine 10 according to an embodiment of the present invention is described with reference to the perspective view shown in FIG. 2. The slot machine 10 is installed in a gaming facility.

In the slot machine 10, coins, bills, and electronic value information equivalent thereto are used as a game medium for executing a unit game. However, in the present embodiment, the game medium is not limited in particular to those described above. For example, medals, tokens, electronic money, tickets can be enumerated. As a game medium to be paid out, coins, bills, and game media including electronic value information equivalent thereto are also used. As a ticket described above, a barcode ticket, to be described later, etc., is used, for example, however, this is not limited.

As shown in FIG. 2, the slot machine 10 includes the cabinet 11, a top box 12 installed on the upper side of the cabinet 11, and a main door 13 provided on the front of the cabinet 11.

Within the cabinet 11, the liquid crystal display 17 for scrolling symbols in a matrix with five transverse squares and three longitudinal squares (referred simply to as 5×3 squares in some cases, hereinafter) is provided. The liquid crystal display 17 includes the display areas 28 (28a to 28o) for displaying symbols in the 5×3 squares. In other words, when the base game is executed, the symbol column is scrolled in each of the display areas 28 (28a to 28o) with 5×3 squares. The player can visually recognize the symbols being scrolled.

In the present embodiment, an example has been described, in which the liquid crystal display 17 has the display areas 28 (28a to 28o) with 5×3 squares, however, the display areas (28a to 28o) are not limited to the 5×3 squares.

In front of the liquid crystal display 17 installed on the main door 13, a lower image display panel 16 (display) is provided. The lower image display panel 16 includes a transparent liquid crystal panel for displaying various items of information about the game, effect images, etc., during the game.

The lower image display panel 16 is provided with a credit number display 31 and a payout (award) number display 32. The credit number display 31 displays the number of credited coins in an image. The payout number display 32 displays the number of coins to be paid out when a combination of symbols having stopped, to be described later, is a combination accompanied by the payout (referred to as a winning combination, hereinafter) in an image.

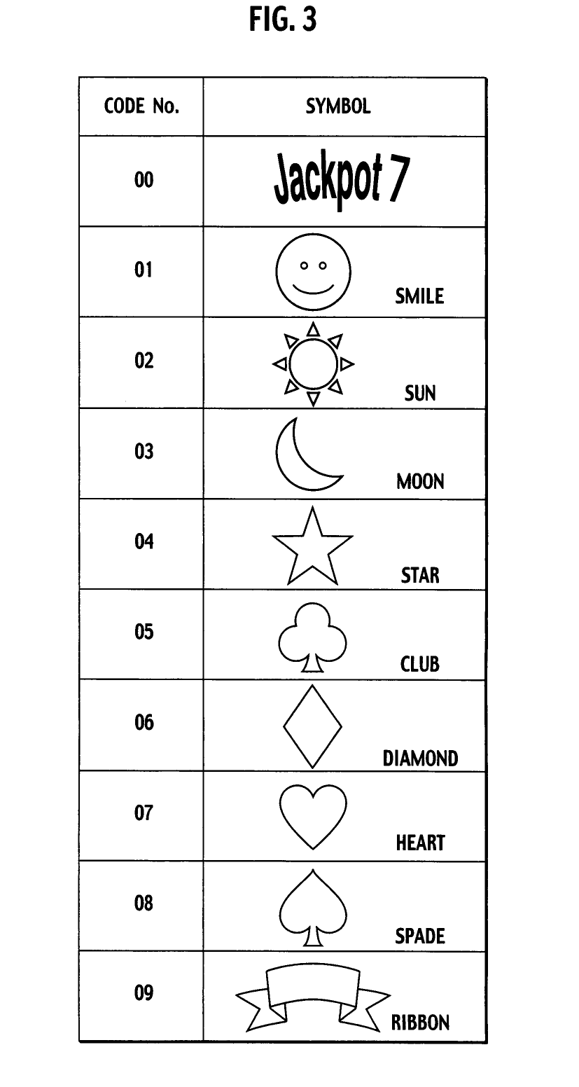

As shown in FIG. 3, the lower image display panel 16 scrolls symbols in the display areas 28 (28a to 28o). Each symbol column consists of 10 symbols shown in FIG. 3 and each symbol constituting the symbol column is assigned in advance any of code numbers 00 to 09. After scrolling symbols in the display areas 28 (28a to 28o), the lower image display panel 16 stops the symbols in each of the display areas 28 (28a to 28o). In other words, the lower image display panel 16 can display a symbol matrix.

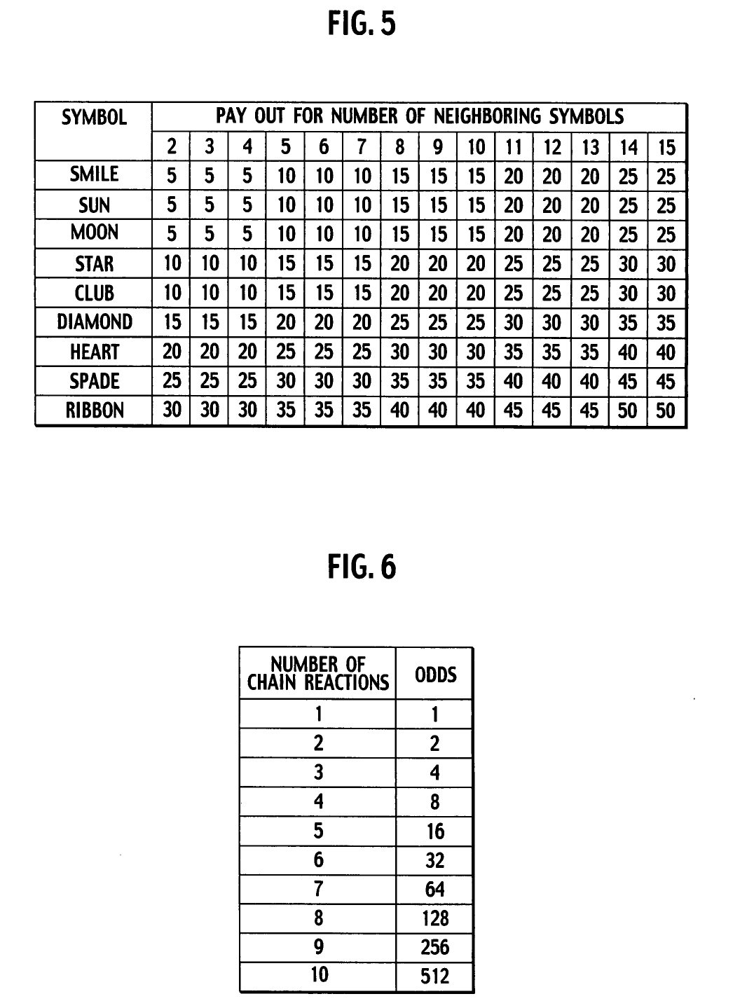

In the embodiment of the present invention, a so-called winning line (referred to as a payline, hereinafter) is not set, instead, the payout is made in accordance with the payout table and odds table shown in FIG. 5 and FIG. 6.

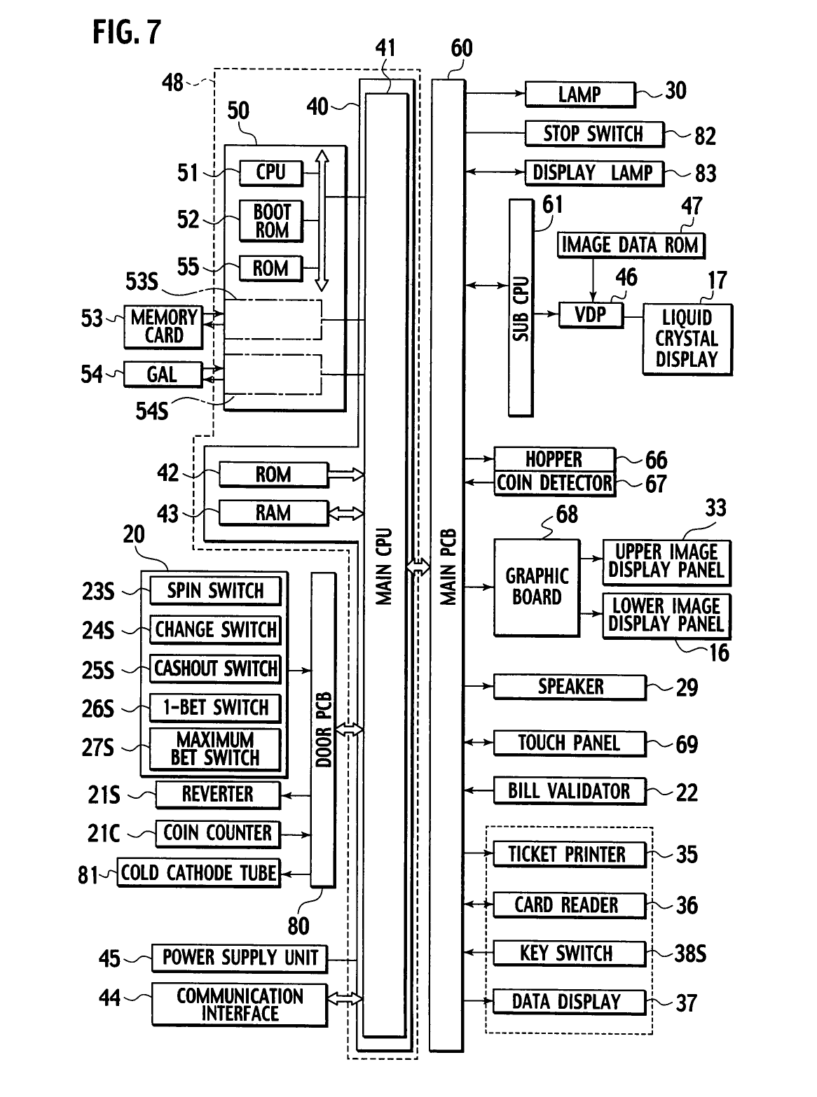

Further, on the front of the lower image display panel 16, a touch panel 69 (refer to FIG. 7) is provided and thereby a player can make various directions by operating the touch panel 69.

Below the lower image display panel 16, a control panel 20 including a plurality of buttons 23 to 27 for a player to specify directions relating to the progress of a game, the coin receiving slot 21 for receiving coins in the cabinet 11, and a bill validator 22 are provided.

The control panel 20 is provided with the spin button 23, a change button 24, a cashout button 25, a 1-BET button 26, and a maximum BET button 27. The spin button 23 is a button to input a direction to start the scroll of the symbols displayed in the display areas 28. The change button 24 is a button to request personnel in the gaming facility for exchange. The cashout button 25 is a button to input a direction to payout credited coins onto a coin tray 18.

The 1-BET button 26 is a button to input a direction to bet one coin of the credited coins on a game. The maximum BET button 27 is a button to input a direction to bet the maximum number of coins that can be bet on a single game (for example, 50 coins) of the credited coins.

The bill validator 22 discriminates whether or not the bill is legitimate and accepts the legitimate bill into the cabinet 11. In addition, it may also be possible for the bill validator 22 to be configured so as to be capable of reading a barcode ticket 36, to be described later. On the lower front of the main door 13, that is, below the control panel 20), a burry glass 34, on which the character of the slot machine 10 etc. is drawn, is provided.

On the front of the top box 12, an upper image display panel 33 is provided. The upper image display panel 33 includes a liquid crystal panel and for example, effect images and images of the introduction of the game content and the explanation of the game rules are displayed thereon.

The top box 12 is provided with a speaker 29 for outputting sound. On the lower side of the upper image display panel 33, a ticket printer 35, a card reader 36, a data display 37, and a keypad 38 are provided.

The ticket printer 35 prints out the barcode ticket 39 on which data of the total number of credits, the number of credits for jackpot, the date, the identification number of the slot machine 10, etc., has been encoded into barcode and printed thereon. The player can play a game with another slot machine using the barcode ticket 39 and exchange the bar code ticket 39 with bills etc. at a cashier etc. in the gaming facility.

The card reader 36 reads and writes data from and to a smart card. The smart card is carried by a player, and in which, for example, data for identifying the player, data about the history of the games played by the player are stored.

The data display 37 is constituted by a fluorescent display etc., and displays, for example, the data read by the card reader 36 and the data input by the player through the keypad 38. Directions and data about issuance of tickets etc. are input through the keypad 38.

FIG. 3 is an explanatory diagram showing an example of a symbol column to be scrolled in each of the display areas 28 (28a to 28o) provided on the liquid crystal display 17 provided within the cabinet 11. As shown in FIG. 3, a column of a total of 10 symbols assigned one of code numbers “00” to “09” is scrolled in each of the display areas 28 (28a to 28o). The order of symbols may differ for each of the display areas 28 (28a to 28o).

As symbols to be displayed in each of the display areas 28 (28a to 28o), there are “JACKPOT 7”, “SMILE”, “SUN”, “MOON”, “STAR”, “CLUB”, “DIAMOND”, “HEART”, “SPADE”, and “RIBBON”. In addition, winning combinations formed when symbols shown in FIG. 3 come adjacent to one another are set. In the chain reaction game, as a table for determining a payout when a winning combination is achieved, the payout table shown in FIG. 5 and the odds table shown in FIG. 6 are set.

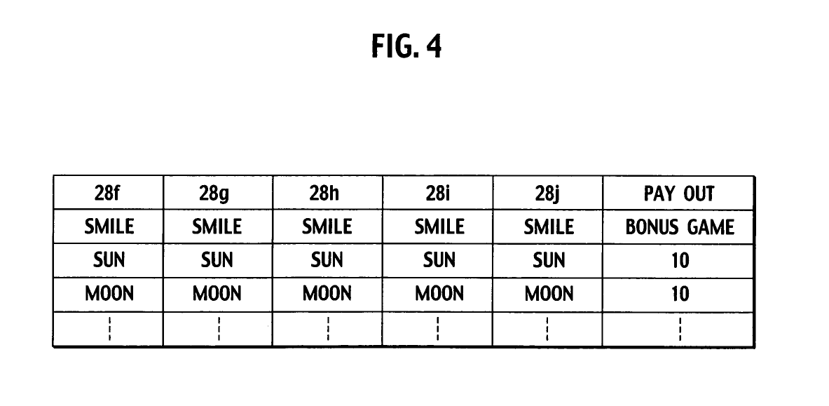

FIG. 4 shows an example of the payout table for providing the bonus game or other payout. The payout table is referred to when the normal base game is being executed. When the symbols shown in the table in FIG. 4 stop altogether in a prescribed transverse row (the display areas 28f to 28i) in the display areas 28 (28a to 28o), a corresponding payout or game is provided based on the table shown in FIG. 4. For example, when the “SMILE” symbols stop in a specific transverse row, that is, the display areas 28f to 28i, the bonus game is provided. In other words, the combination in which the “SMILE” symbols align in the display areas 28f to 28i is a bonus trigger and when the combination is achieved, the gaming state transits from the base game to the bonus game. When the “SUN” or “MOON” symbols have stopped altogether in the display areas 28f to 28i, a payout of 10 coins is made. Although not shown, when the combination of the “JACKPOT_{—}7” symbols has stopped in the display areas 28f to 28i, a payout of jackpot may be executed.

In the present invention, it is required for the bonus game only to be a game that transits to the gaming state advantageous for a player and the progress of the game or its processing is not limited in particular. The bonus game advantageous for the player is not limited in particular provided that it is more advantageous than the base game and such states include a state in which more game media can be obtained than the base game, a state in which the game media can be obtained with a higher probability than the base game, a state in which less game media are consumed than the base game, etc. Specifically, the bonus game includes the free game, the second game, etc.

The symbols displayed (arranged) in each of the 15 display areas 28 (28a to 28o) start to scroll when the BET button 26 or the maximum BET button 27 has been pressed and then the spin button 23 is pressed. In each of the display areas 28a to 28o, when the symbols start to scroll, after a prescribed period of time elapses, the scroll of each symbol stops simultaneously or sequentially. This state is referred to as a rearranged state. On this occasion, in each of the display areas 28 (28a to 28o), a symbol specified by any one of the code numbers in the symbol column shown in FIG. 3 stops.

On this occasion, as described above, specific winning combinations (refer to FIG. 4) are determined in advance and when symbols forming a winning combination stop in prescribed display areas, a payout based on the payout table in FIG. 4 is made. When the bonus game trigger is achieved, in other words, in the present embodiment, when the “SMILE” symbols stop in the display areas 28f to 28i, the gaming mode transits from the base gaming mode to the bonus gaming mode.

FIG. 7 is a block diagram showing the control circuit of the slot machine 10 shown in FIG. 2. As shown in FIG. 7, the control circuit includes a controller 48, a main PCB (Printed Circuit Board) 60, a sub CPU 61, a door PCB 80 and various components, such as switches, sensors, etc. The controller 48 includes a motherboard 40 and a gaming board 50.

The gaming board 50 includes a CPU (Central Processing Unit) 51, a ROM 55 and a boot ROM 52, a card slot 53S corresponding to a memory card 53, and an IC socket 54S corresponding to a GAL (Generic Array Logic) 54, all these connected to one another by an internal bus.

The memory card 53 stores game programs and game system programs. The game programs include a stop symbol determination program. The stop symbol determination program is a program for determining symbols (code numbers corresponding to symbols) that stop in each of the display areas 28 (28a to 28o). The stop symbol determination program includes symbol weighted data corresponding to respective payout rates (for example, 80%, 84%, 88%) of plural kinds. The symbol weighted data is data showing a correspondence relationship between the code number of each symbol (refer to FIG. 3) and one or more random number values belonging to a prescribed numerical range (0 to 256) in relation to each of the display areas 28 (28a to 28o).

The payout rate is determined based on payout rate setting data output from the GAL 54 and based on the weighted data of the symbol corresponding to the payout rate, the stop symbols are determined.

The card slot 53S is configured so that the memory card 53 can be inserted and removed and is connected to the motherboard 40 by an IDE bus. Consequently, by removing the memory card 53 from the card slot 53S, writing another game program and game system program to the memory card 53, and inserting the memory card 53 into the card slot 53S, it is possible to change the kinds and contents of the game played with the slot machine 10.

The game program includes programs relating to game progress and programs to switch over to the bonus game. In addition, the game program includes image data and audio data output during the game. Further, the game program includes image data and audio data as notification data for notifying the player when a chain reaction game is started according to the procedure, to be described later.

The GAL 54 includes a plurality of input ports and output ports and when data is input to the input port, it outputs data corresponding to the data from the output port. The data output from the output port is the above-described payout rate setting data.

In addition, the IC socket 54S is configured so that it can attach/remove the GAL 54 and is connected to the motherboard 40 by a PCI bus. Consequently, by removing the GAL 54 from the IC socket 54S, rewriting the program stored in the GAL 54, and attaching the GAL 54 to the IC socket 54S, it is possible to change the payout rate setting data output from the GAL 54.

The CPU 51, the ROM 55, and the boot ROM 52 connected to one another by the inner bus are connected to the motherboard 40 by the PCI bus. The PCI bus transmits signals between the motherboard 40 and the gaming board 50 and at the same time, supplies electric power from the motherboard 40 to the gaming board 50. In the ROM 55, country identification information and an authentication program are stored. In the boot ROM 52, a preliminary authentication program, a program (boot code) with which the CPU 51 activates the preliminary authentication program, etc., are stored.

The authentication program is a program (falsification check program) for authenticating the game program and the game system program. The authentication program is a program for checking and proving that the game program and the game system program have not been falsified. In other words, the authentication program is written in accordance with the authentication procedure of the game program and the game system program. The preliminary program is a program for authenticating the above-described authentication program. The preliminary authentication program is written in accordance with the procedure for proving that the authentication program to be subjected to the authentication processing has not been falsified, that is, for authenticating the authentication program.

The motherboard 40 includes a main CPU 41, a ROM (Read Only Memory) 42, a RAM (Random Access Memory) 43, and a communication interface 44.

The main CPU 41 comprises a function as a controller to control the entire slot machine 10. In particular, the main CPU 41 executes control of, when the spin button 23 is pressed after credits have been bet, outputting a direction signal causing the sub CPU 61 to scroll symbols in each of the display areas 28 (28a to 28o) of the liquid crystal display 17, control of determining symbols that stop after the symbols are scrolled in each of display areas 28 (28a to 28o), and control of stopping and displaying the determined symbols as a symbol matrix.

After scrolling the symbol columns arranged on the display (liquid crystal display 17) in one direction, the main CPU 41 executes arrangement control of selecting and determining symbols to be arranged in a symbol matrix from among the plurality of symbols and stopping scroll state with the determined symbols in order to rearrange the symbol columns as a new symbol matrix.

In addition, the main CPU 41 executes control of, when symbols are arranged on the display (liquid crystal display 17) and if there exist a prescribed number or more of neighboring symbols having the same attribute, that is, symbols on which the same picture is drawn, deleting the combination formed by these symbols and shifting the symbols arranged as the symbol matrix in a prescribed direction to rearrange them in the display areas that have become vacant due to the deletion.

Further, the main CPU 41 accumulatively records part of credits to be paid out to the player as credits for jackpot in the slot machine 10. The main CPU 41 determines whether or not to payout the credits for jackpot accumulatively recorded when the number of credits becomes not less than a prescribed jackpot threshold value (for example, “500”). Furthermore, the main CPU 41 pays out the credits for jackpot when the winning combination (specifically, the five “JACKPOT_{—}7” symbols) accompanied by a jackpot payout is achieved in the display areas 28f to 28i.

As in the slot machine 10, in a slot machine of stand-alone type, the jackpot credits are recorded in the RAM 43. In contrast to this, in the case of a slot machine corresponding to the progressive system to which a plurality of slot machines and a management server are connected, part of credits paid out to the player at each slot machine is recorded in the management server and the payout of credits is made from the management server for the slot machine that has satisfied prescribed conditions.

The main CPU 41 outputs a scroll direction signal to the effect that each of the display areas 28 (28a to 28o) scrolls symbols in the base game execution processing to a graphic board 68. The graphic board 68 controls the lower image display panel 16 based on the scroll direction signal. The lower display panel 16 scrolls symbols in each of the display areas 28 (28a to 28o) by the control of the graphic board 68 (in other words, control by the main CPU 41).

The main CPU 41 determines symbols to stop in each of the display areas 28 (28a to 28o) and outputs a stop direction signal about the determined symbol to the graphic board 68. The graphic board 68 controls the lower image display panel 16 based on the stop direction signal. The lower image display panel 16 stops and displays the determined symbol by the control of the graphic board 68.

The main CPU 41 determines a combination when all of the symbols in the display areas 28 have stopped by the control of the graphic board 68 based on the payout table. On this occasion, when a combination accompanied by a payout has been achieved, the main CPU 41 calculates the payout. Then, when symbols are arranged on the display (liquid crystal display 17) and if a prescribed number or more of symbols having the same attribute are arranged side by side, the main CPU 41 performs execution processing of a chain reaction game and deletes the combination. After that, the main CPU 41 shifts prescribed neighboring symbols from among the symbol matrix to rearrange them in the display areas that have become vacant due to the deletion. In other words, the main CPU 41 executes the base game in which the plurality of symbols arranged on the display are rearranged automatically and the chain reaction game in which the achieved combination is deleted from the rearranged state after the scroll and the symbols are rearranged by shifting them.

Then, when a combination accompanied by a payout is formed by the arrangement of a prescribed number or more of neighboring symbols when the scroll stops etc., and/or when a combination accompanied by the payout is formed again in a symbol matrix formed by the rearrangement after the combination has been achieved, the main CPU 41 executes control of making the payout in accordance with each combination.

In the ROM 42, programs, such as the BIOS (Basic Input/Output System) etc. to be executed by the main CPU 41, are stored and data to be used permanently is stored. When the main CPU 41 executes the BIOS, initialization processing of each peripheral is performed and at the same time, read processing of the game program and game system program stored in the memory card 53 via the gaming board 50 is started. In addition, the ROM 42 is also used as a memory for storing a combination accompanied by a payout and the number of credits to be paid out in accordance with the combination.

The main CPU 41 determines whether the symbols in the symbol matrix formed when symbols stop and/or the symbols in the rearranged symbol matrix are set in the payout table stored in the ROM 42.

In the RAM 43, data and programs used when the main CPU 41 performs processing are stored. In addition, there is provided a counter that counts the number of successive times a combination accompanied by the payout is formed when symbols successively form a combination accompanied by the payout by the rearrangement of the symbol matrix by the main CPU 41. Further, in the case where the slot machine 10 is a so-called slot machine of stand-alone type, the number of jackpot credits is stored in the RAM 43.

The communication interface 44 is used to communicate with the host computer etc. provided in the gaming facility via a communication line.

Also, to the motherboard 40, the main body PCB (Printed Circuit Board) 60 and a door PCB 80, to be described later, are connected respectively by the USB (Universal Serial Bus). Further, to the motherboard 40, a power supply unit 45 is connected. When electric power is supplied from the power supply unit 45 to the motherboard 40, the main CPU 41 of the motherboard 40 is activated and at the same time, electric power is supplied to the gaming board 50 by the PCI bus and the CPU 51 is activated.

The controller 48 is constituted by each configuration of the motherboard 40 and the gaming board 50 described above. After scrolling a plurality of symbols arranged on the lower image display panel 16, the controller 48 selects and determines symbols to be arranged in the symbol matrix from among the plurality of symbols having different attributes from one another. Next, the controller 48 executes arrangement control of stopping scroll state with the determined symbols. After that, when symbols are arranged on the lower image display panel 16 and if there exist a prescribed number or more of neighboring symbols having the same attribute, the controller 48 deletes the prescribed number or more of neighboring symbols. Further, the controller 48 executes rearrangement control of shifting symbols arranged as the symbol matrix in a prescribed direction to rearrange them in the vacant areas from which the symbols have been deleted. Then, the controller 48 determines whether the symbols when the scroll of the symbols stops and the symbols rearranged as a symbol matrix form the combination accompanied by the payout stored in the ROM 42. When the stopped symbols and the symbols rearranged as a symbol matrix form a combination accompanied by the payout, the controller 48 executes control of making the payout in accordance with the combination.

When the rearranged symbols successively form a combination accompanied by the payout, the controller 48 refers to the counter provided in the RAM 43 to count the number of successive times the combination accompanied by the payout is formed and executes control of making the payout in accordance with the combination and the number of successive times of the achieved combination.

To the main PCB 60 and the door PCB 80, equipment and devices to generate input signals to be input to the main CPU 41 and equipment and devices the operation of which is controlled by the control signal output from the main CPU 41 are connected. By executing the game program and the game system program stored in the RAM 43 based on the input signal input to the main CPU 41, the main CPU 41 performs arithmetic processing and stores its result in the RAM 43 and performs processing to transmit the control signal to each equipment and device as control processing for each equipment and device.

To the main body PCB 60, a lamp 30, the sub CPU 61, a hopper 66, a coin detector 67, the graphic board 68, the speaker 29, the touch panel 69, the bill validator 22, the ticket printer 35, the card reader 36, a key switch 38si and the data display 37 are connected. Further, to the main PCB 60, a stop switch 82 and a display lamp 83 provided corresponding to the stop switch 82 are connected.

The lamp 30 is controlled so that it lights up or lights off based on the control signal output from the main CPU 41.

The sub CPU 61 controls the scroll of symbols in each of the display areas 28 (28a to 28o) set on the liquid crystal display 17 and is connected with a VDP (Video Display Processor) 46.

The VDP 46 reads image data of symbols stored in an image data ROM 47, generates a scroll image to be displayed on the liquid crystal display 17, and outputs the scroll image to the liquid crystal display 17.

The hopper 66 is placed inside the cabinet 11 and pays out a prescribed number of coins onto the coin tray 18 through a coin payout opening 19 based on the control signal output from the main CPU 41. The coin detector 67 is provided inside the coin payout opening 19 and outputs an input signal to the main CPU 41 when detecting that the prescribed number of coins has been paid out through the coin payout opening 19.

The graphic board 68 controls the image display other than that of the symbols to be displayed in the display areas 28 on the upper image display panel 33 and the lower image display panel 16 based on the control signal output from the main CPU 41. In the credit number display 31 of the lower image display panel 16, the number of credits stored in the RAM 43 is displayed. In the payout number display 32 of the lower image display panel 16, the number of coins paid out is displayed. In addition, the graphic board 68 includes a VDP that generates image data based on the control signal output from the main CPU 41, a video RAM that temporarily stores image data generated by the VDP, etc.

The bill validator 22 reads the image of a bill and accepts a legitimate bill into the cabinet 11. When accepting a legitimate bill, the bill validator 22 outputs an input signal to the main CPU 41 based on the amount of the bill. The main CPU 41 stores the number of credits in accordance with the amount of the bill transmitted by the input signal.

The ticket printer 35 prints out barcode, into which data, such as the number of credits stored in the RAM 43, date, the identification number of the slot machine 10, etc., is encoded, onto a ticket and outputs as the barcode ticket 39.

The card reader 36 reads data from the smart card and transmits it to the main CPU 41 and writes data to the smart card based on the control signal from the main CPU 41. The key switch 38S is provided to the keypad 38 and outputs an input signal to the main CPU 41 when a player operates the keypad 38.

The data display 37 displays data read by the card reader 36 and data input by a player via the keypad 38 based on the control signal output from the main CPU 41.

To the door PCB 80, the control panel 20, a reverter 21S, a coin counter 21C, and a cold cathode tube 81 are connected. The control panel 20 is provided with a spin switch 23S corresponding to the spin button 23, a change switch 24S corresponding to the change button 24, a cashout switch 25S corresponding to the cashout button 25, a 1-BET switch 26S corresponding to the 1-BET button 26, and a maximum BET switch 27S corresponding to the maximum button 27. Each of the switches 23S to 27S outputs an input signal to the main CPU 41 when a play operates each of the corresponding buttons 23 to 27.

The coin counter 21C is provided inside the coin insertion slot 21 and validates whether or not the coin inserted into the coin insertion slot 21 by a player is legitimate. Coins other than legitimate ones are ejected from the coin payout opening 19. In addition, the coin counter 21C outputs an input signal to the main CPU 41 when detecting the legitimate coin.

The reverter 21S operates based on the control signal output from the main CPU 41 and distributes the coins validated to be legitimate ones by the coin counter 21C to the cash box (not shown) or the hopper 66 provided within the slot machine 10. In other words, when the hopper 66 is filled with coins, the legitimate coins are distributed to the cash box by the reverter 21S. On the other hand, when the hopper 66 is not filled with coins, the legitimate coins are distributed to the hopper 66.

The cold cathode tube 81 functions as a backlight installed on the backside of the lower image display panel 16 and the upper image display panel 33 and lights up based on the control signal output from the main CPU 41.

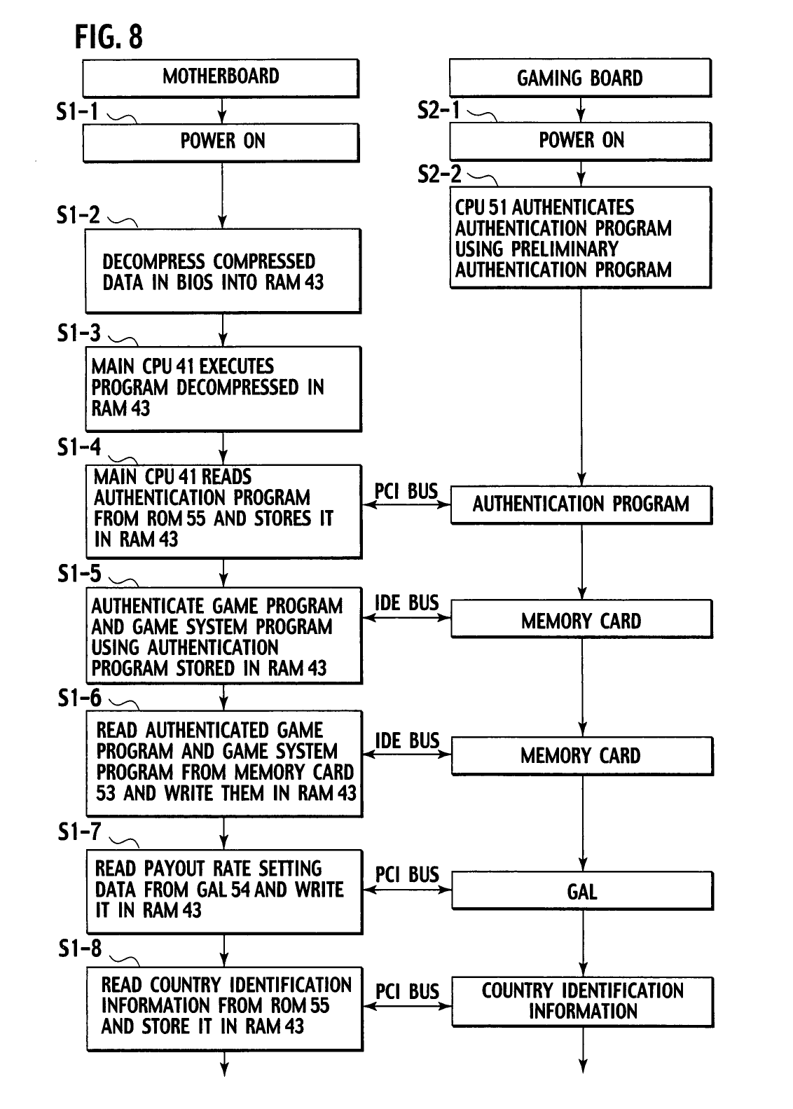

Next, specific processing performed in the slot machine 10 is described. FIG. 8 is a flow chart showing the procedure of authentication read processing (processing in step S100 shown in FIG. 1) of the game program and the game system program by the motherboard 40 and the gaming board 50 shown in FIG. 7. Here, it is assumed that the memory card 53 is attached to the card slot 53S of the gaming board 50 and the GAL 54 is attached to the IC socket 54S.

First, when the power switch is turned on in the power supply unit 45, the motherboard 40 and the gaming board 50 are activated (step S1-1, S2-1). When the motherboard 40 and the gaming board 50 are activated, processing is performed at the same time, individually. In other words, on the gaming board 50, the CPU 51 reads the preliminary authentication program stored in the boot ROM 52. Next, the CPU 51 carries out preliminary authentication in advance to check and prove that the authentication program has not been falsified in accordance with the read preliminary authentication program before taken into the motherboard 40 (step S2-2).

On the other hand, on the motherboard 40, the main CPU 41 executes the BIOS stored in the ROM 42 and decompresses the compressed data incorporated in the BIOS into the RAM 43 (step S1-2). Then, the main CPU 41 executes the BIOS decompressed in the RAM 43 and diagnoses and initializes the various peripheral devices (step S1-3).

Then, since the ROM 55 of the gaming board 50 is connected to the main CPU 41 by the PCI bus, the main CPU 41 reads the authentication program stored in the ROM 55. Further, the main CPU 41 performs processing to store the read authentication program in the RAM 43 (step S1-4).

Next, the main CPU 41 accesses the memory card 53 attached to the card slot 53S via the IDE bus. Then, the main CPU 41 reads the game program and the game system program stored in the memory card 53.

Next, the main CPU 41 performs authentication processing to check and prove that the read game program and game system program have not been falsified in accordance with the authentication program stored in the RAM 43 (step S1-5).

When the authentication processing is completed normally, the main CPU 41 stores the authenticated game program and game system program in the RAM 43 (step S1-6). Next, the main CPU 41 accesses the GAL 54 attached to the IC socket 54S via the PCI bus and reads the payout rate setting data from the GAL 54, and stores it in the RAM 43 (step S1-7). Next, the main CPU 41 reads the country identification information stored in the ROM 55 of the gaming board 50 via the PCI bus and stores the read country identification information in the RAM 43 (step S1-8).

After performing the above-described processing, the main CPU 41 advances the base game described below by sequentially reading and executing the game program and the game system program.

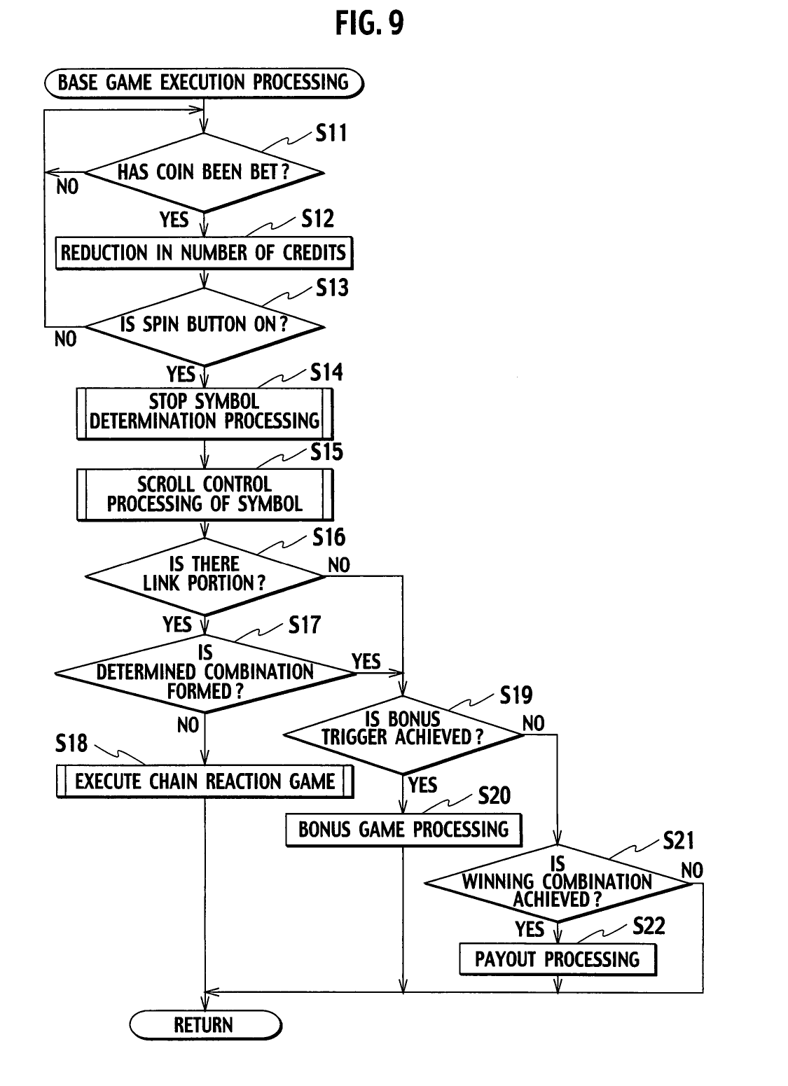

After the authentication read processing shown in FIG. 8 is performed, the main CPU 41 performs the execution processing of the base game. FIG. 9 is a flow chart showing the specific processing procedure of the base game execution processing shown in step S200 in FIG. 1.

In the base game execution processing, first, the main CPU 41 determines whether or not a coin(s) has been bet (step S11). In this processing, the main CPU 41 determines whether or not it has received an input signal output from the 1-BET switch 26S when the 1-BET button 26 is pressed or an input signal output from the maximum BET switch 27S when the maximum BET button 27 is pressed. When the main CPU 41 determines that no coin has been bet, it returns the processing to step S11.

On the other hand, when it is determined that a coin(s) has been bet, the main CPU 41 performs processing to reduce the number of credits stored in the RAM 43 in accordance with the number of coins bet (step S12). If the number of coins bet is greater than the number of credits stored in the RAM 43, the main CPU 41 does not perform the processing to reduce the number of credits stored in the RAM 43 and returns the processing to step S11. In addition, when the number of coins bet exceeds the upper limit value that can be bet on a single game (50 coins in the present embodiment), the main CPU 41 does not perform the processing to reduce the number of credits stored in the RAM 43 and advances the processing to step S13. In this state, symbols can be scrolled in the display areas 28 (28a to 28o).

Next, the main CPU 41 determines whether or not the spin button 23 has been turned ON (step S13). In this processing, the main CPU 41 determines whether or not it has received an input signal output from the spin switch 23S when the spin button 23 is turned ON. When the main CPU 41 determines that the spin button 23 has not been turned ON, it returns the processing to step S11. When the spin button 23 has not been turned ON (for example, the spin button 23 has not been turned ON but a game ending direction is input), the main CPU 41 cancels the result of reduction in step S12.

In the present embodiment, a case is described, in which after a coin(s) has been bet and before whether or not the spin button 23 has been turned ON is determined (step S13), the processing to reduce the number of credits is performed (step S12). However, the present invention is not limited to this example. For example, after a coin(s) has been bet (step S11), whether or not the spin button 23 has been turned ON is determined (step S13), and when it is determined that the spin button 23 has been turned ON (YES in step S13), the processing to reduce the number of credits may be performed (step S12).

Then, when it is determined that the spin button 23 has been turned ON, the main CPU 41 performs stop symbol determination processing (step S14). In the stop symbol determination processing, the main CPU 41 executes the scroll control processing of symbols (step S15) by executing the stop symbol determination program stored in the RAM 43 and determines symbols to be displayed when they stop in each of the display areas 28 (28a to 28o).

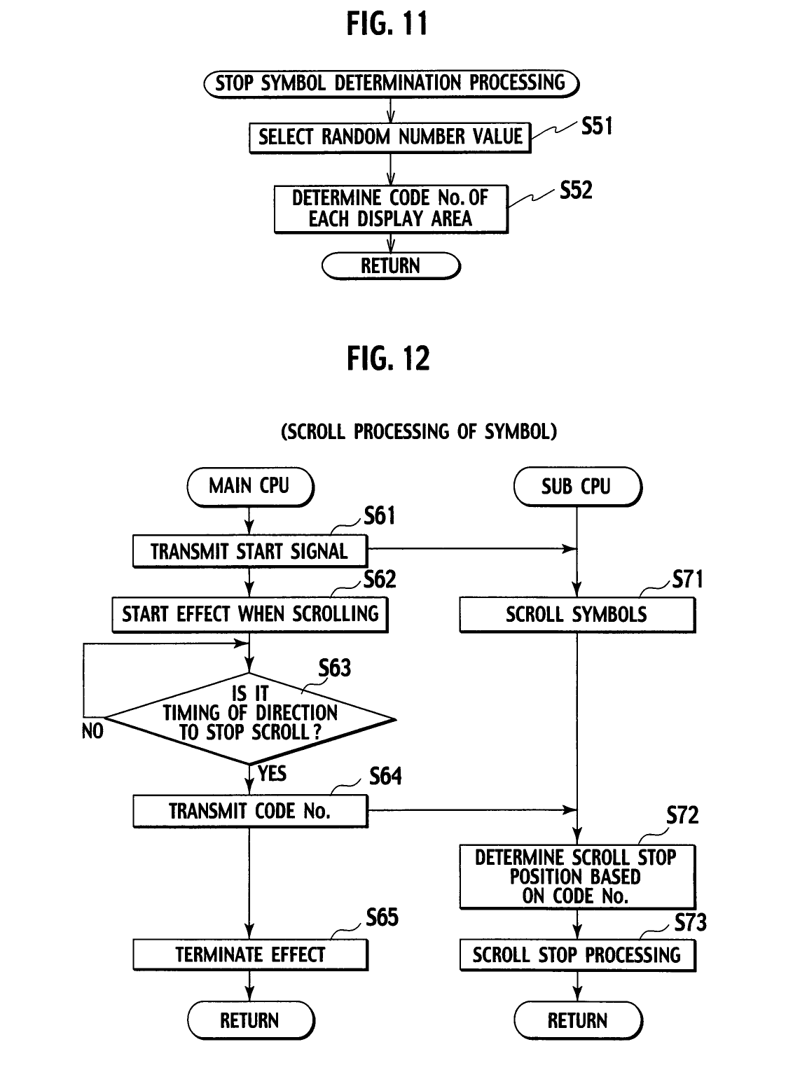

Next, the main CPU 41 performs the scroll processing of symbols (step S15). In this processing, after the scroll of symbols is started in each of the display areas 28 (28a to 28o), the symbols determined in step S14 are stopped in each of the display areas 28 (28a to 28o). The stop symbol determination processing will be described later using FIG. 11. The scroll control processing will be described later using FIG. 12.

Next, the main CPU 41 determines whether or not there is a symbol link portion in the symbol matrix stopped and displayed in the scroll control processing (step S16).

When there is a symbol link portion and if a prescribed number or more of neighboring symbols having the same attribute are arranged, whether or not a determined combination of symbols is achieved is further determined (step S17). The combination of symbols referred to here is a combination set in the payout table in order to provide the bonus game or other payout shown in FIG. 4. When a symbol link is achieved but it is not a combination set in the payout table shown in FIG. 4 (NO in step S17), the game is switched over to the chain reaction game (step S18).

On the other hand, when there is no symbol link (NO in step S16) or when a symbol link is achieved and a combination set in the payout table shown in FIG. 4 is achieved (NO in step S17), the main CPU 41 determines whether the bonus trigger is achieved (step S19) and when the bonus trigger set in the payout table shown in FIG. 4 is achieved (YES in step S19), the processing proceeds to the bonus game processing (step S20).

When the bonus trigger is not achieved (NO in step S19), whether or not another winning combination is achieved is further determined (step S21). When a winning combination set in the payout table shown in FIG. 4 is achieved (YES in step S21), the processing proceeds to the payout processing in accordance with the winning combination (step S22). When part of credits to be paid out is saved, the main CPU 41 adds a prescribed number of credits to the number of credits stored in the RAM 43. When paying out credits, the main CPU 41 transmits a control signal to the hopper 66 and pays out a prescribed number of credits. On this occasion, the coin detector 67 counts the number of coins paid out from the hopper 66 and when the counted value reaches a specified number, it transmits a payout complete signal to the main CPU 41. With this, the main CPU 41 terminates the drive of the hopper 66 and the payout processing of coin is completed. On the other hand, when a winning combination is not achieved (NO in step S21), that is, when losing, no payout of credit is made. The base game is executed as described above.

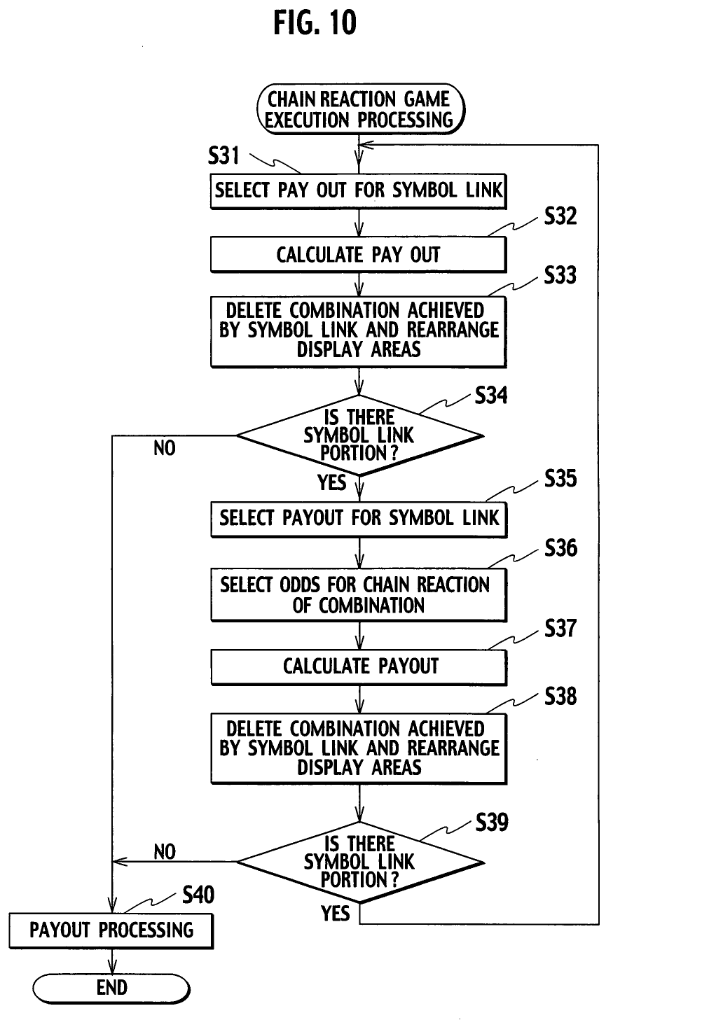

Next, chain reaction game execution processing in the embodiment of the present invention is described using FIG. 10.

The main CPU 41 executes stop symbol determination processing to be described later in the base game and symbols to be stopped and displayed in each of the display areas 28 (28a to 28o) are determined. Then, as a result of the scroll control processing of symbols by the main CPU 41, symbols are stopped and displayed in each of the display areas and a symbol matrix is formed.

The main CPU 41 calculates the payout of the symbol link portion in the symbol matrix formed by the symbols determined in the symbol matrix (step S31).

On this occasion, the main CPU 41 selects a payout of credits in accordance with the symbols and the number of link portions from the payout table to set the payout of credits in accordance with the number of neighboring symbols shown in FIG. 5 (step S31). In addition, the main CPU 41 counts the number of times of the chain reaction of combination. If no chain reaction of combination has occurred, the count value is one at this point of time.

The setting is made so that if at least two symbols are linked to each other in the display areas 28a to 28o, and therefore, a payout is caused, and the number of combinations achieved by the symbol link in one symbol matrix is not limited to one. When two or more combinations are achieved, the main CPU 41 selects the payout of credits for each combination and calculates its payout (step S32).

Subsequently, the main CPU 41 executes control of deleting the combination achieved by the symbol link from the display areas and shifting in a prescribed direction the symbols arranged as the symbol matrix to rearrange them in the display areas having become vacant due to the deletion (step S33).

The main CPU 41 determines whether there exists any symbol link portion in the rearranged symbol matrix (step S34) and selects a payout of credits in accordance with the symbols and the number of links from the payout table shown in FIG. 5 (step S35). In addition, the main CPU 41 counts the number of times of the chain reaction of combination and selects odds for the chain reaction of combination based on the odds table in FIG. 6 (step S36).

The main CPU 41 calculates a payout for the achieved combination based on the payout selected in step S35 and the odds selected in step S36 (step S37).

Next, the main CPU 41 again deletes the combination achieved by the symbol link from the display areas and shifts in a prescribed direction the symbols arranged as the symbol matrix to rearrange them in the display areas having become vacant due to the deletion for rearrangement (step S38).

Then, the main CPU 41 determines whether there is any symbol link portion in the symbol matrix formed by the rearrangement and if there is no link portion, the main CPU 41 performs payout processing (step S40).

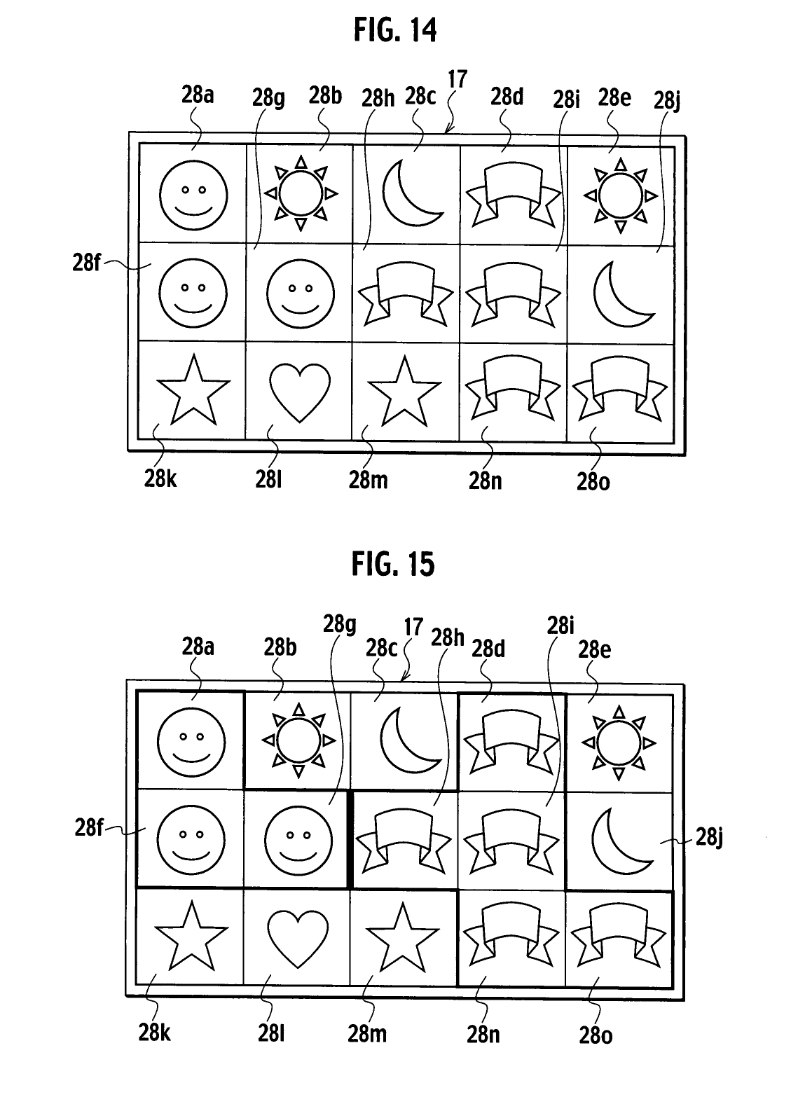

The chain reaction game in the embodiment of the present invention, shown in FIG. 10, is described specifically using the display example of the symbol matrix in the display areas 28 (28a to 28o) shown in FIG. 14 to FIG. 22. Here, the transverse five squares×longitudinal three squares shown in FIG. 14 to FIG. 22 correspond to the respective display areas 28 (28a to 28o) of the liquid crystal display 17 shown in FIG. 2.

When the spin button 23 is pressed by a player in a state in which a desired number of credits has been bet by the insertion of coins into the coin insertion slot 21 etc., the scroll of the symbol column is started in each of the display areas (28a to 28o) of the liquid crystal display 17 provided on the front of the cabinet 11. On this occasion, the main CPU 41 executes stop symbol determination processing and symbols to be stopped and displayed in each of the display areas 28 (28a to 28o) are determined. Then, the scroll of the symbols stops due to the scroll control processing by the main CPU 41 and symbols stop (are rearranged) in each of the display areas 28 (28a to 28o) with 5×3 squares, that is, 15 squares in total. It is assumed here that a symbol matrix shown in FIG. 14 is formed. In other words, this symbol matrix is formed when “SMILE” is stopped and displayed in the display area 28a, “SUN”; in the display area 28e, “MOON”; in the display area 28c, “RIBBON”; in the display area 28d, “SUN”; in the display area 28e, “SMILE”; in the display area 28f, “SMILE”; in the display area 28g, “RIBBON”; in the display area 28h, “RIBBON”; in the display area 28i, “MOON”; in the display area 28j, “STAR”; in the display area 28k, “HEART”; in the display area 28l, “STAR”; in the display area 28m, “RIBBON”; in the display area 28n, and “RIBBON”; in the display area 28o.

In this symbol matrix, the symbols displayed in the display areas shown by the thick frame in FIG. 15 are the same symbols (SMILE, RIBBON) and they are arranged adjacent to each another, and therefore, the main CPU 41 selects a corresponding payout of credits from the payout table shown in FIG. 5. In the symbol matrix shown in FIG. 15, the number of linked “SMILE” symbols is three and the number of linked “RIBBON” symbols is five, both symbol links occurring simultaneously. It may also be possible here to notify the player of the payout using part of the area of the liquid crystal display 17 or voices or music so that the player knows the payout at this point of time. In the case of the symbol matrix shown in FIG. 15, “40”, the number of credits to be paid out is fixed at this point of time.

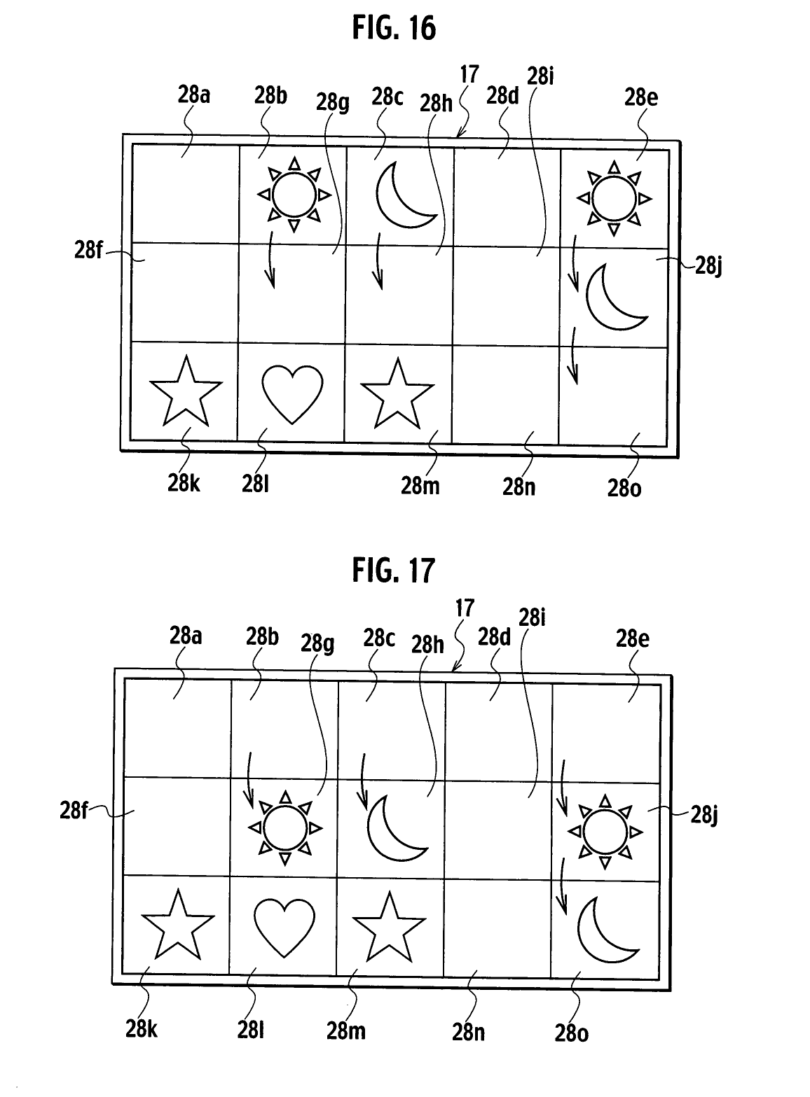

Next, the combinations achieved by the symbol links are deleted from the display areas (refer to FIG. 16). Then, the main CPU 41 executes control to shift in a prescribed direction (in the direction of the arrow in FIG. 16, that is, in the direction of the column) the symbols arranged in the symbol matrix to rearrange and display them in the display areas 28a, 28d, 28f, 28g, 28h, 28i, 28n, and 28o that have become vacant due to the deletion. FIG. 17 shows a display example when the symbols arranged in the symbol matrix have been shifted in the direction of the arrow and displayed. In other words, the symbols that have been displayed in the display areas 28b, 28c, and 28j are now displayed in the display areas 28d, 28e, and 28o.

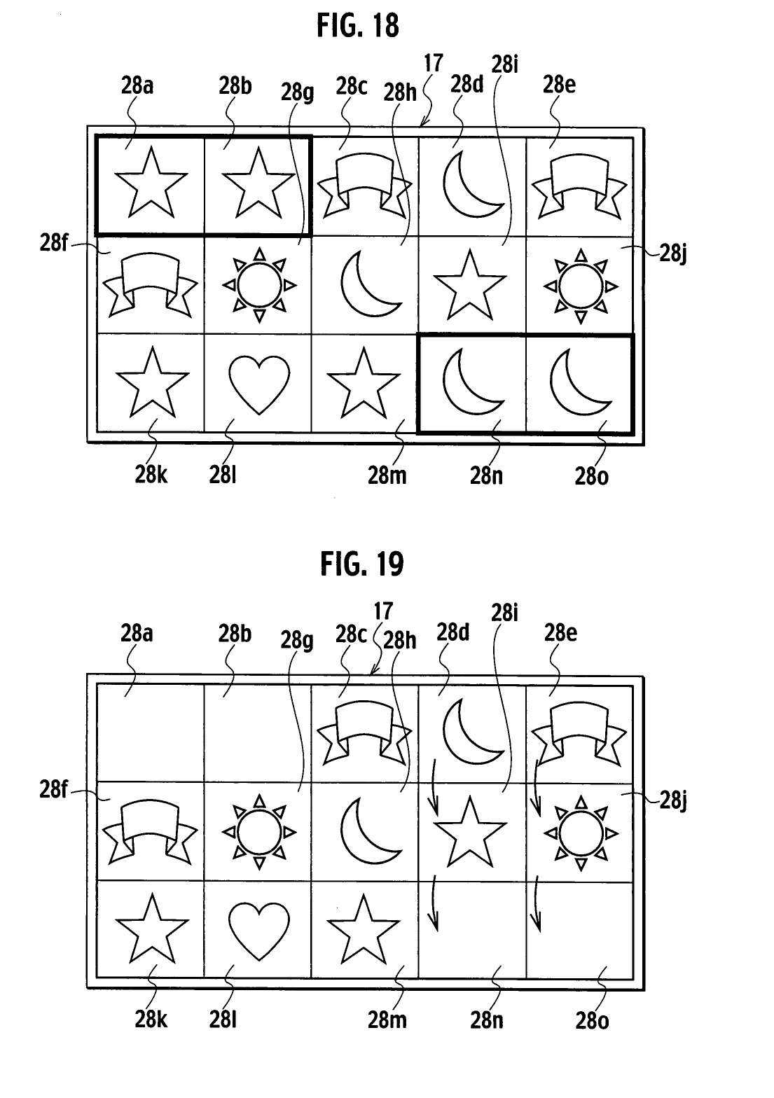

If, for example, there is no relevant symbol in the symbol matrix to be shifted to and displayed in the display area of the liquid crystal display 17, which has become vacant, as in the display areas 28a, 28f, an effect is carried out in which a symbol appears from the outside of the display area. In this manner, the symbol matrix is rearranged (refer to FIG. 18).

FIG. 18 shows an example of a state of a rearranged symbol matrix after step 33 has been executed. In the symbol matrix formed by the rearrangement, in the display area 28a and the display area 28b shown by the thick frame, and also in the display area 28n and the display area 28o, the symbol links are achieved again (“STAR” and “MOON”). In other words, the chain reaction of combination has occurred. As the above-described processing is repeated, a payout based on the number of linked “STAR” symbols, two, and the number of linked “MOON” symbols, two, is selected and these symbols are deleted, and rearrangement is carried out again by shifting and displaying the symbols, as shown in FIG. 19. The number of credits to be paid out for these two combinations is “15”.

It is assumed that a symbol matrix shown in FIG. 20 is formed as a result of the rearrangement. In the example of the symbol matrix shown in FIG. 20, in the display area 28h and the display area 28i shown by the thick frame, and also in the display area 28m and the display area 28n, the symbol links are achieved again (“STAR” and “MOON”). This means that the chain reaction of combination has occurred again.

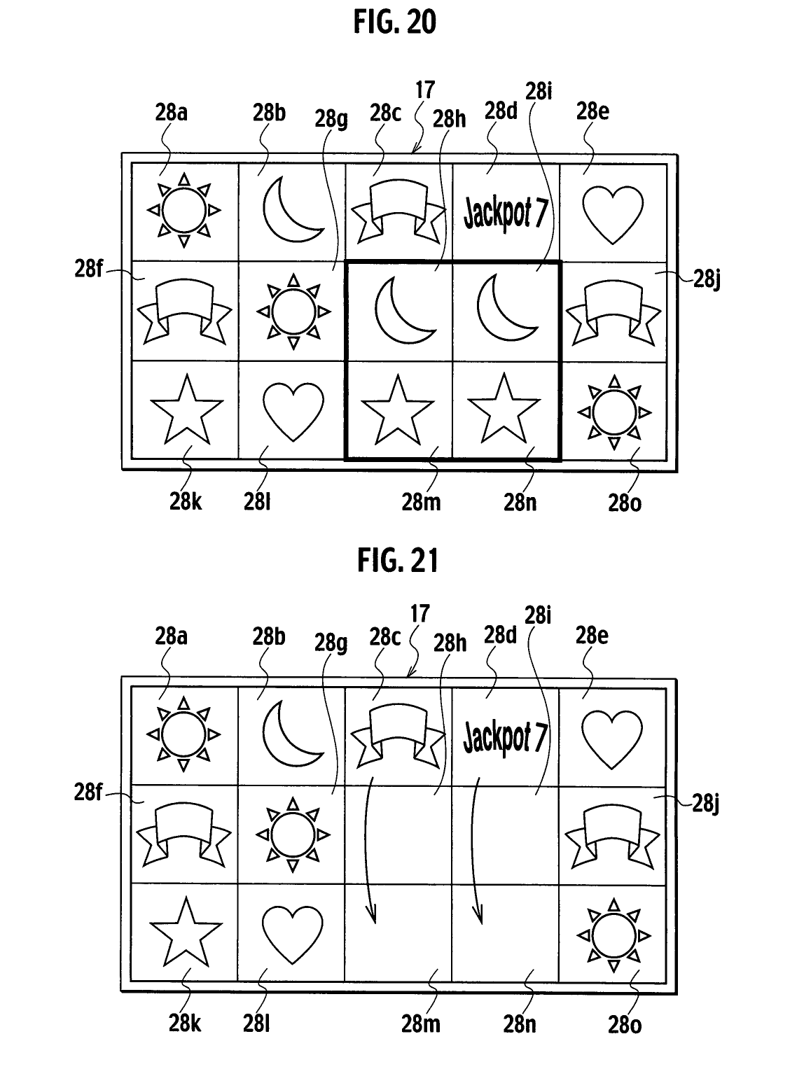

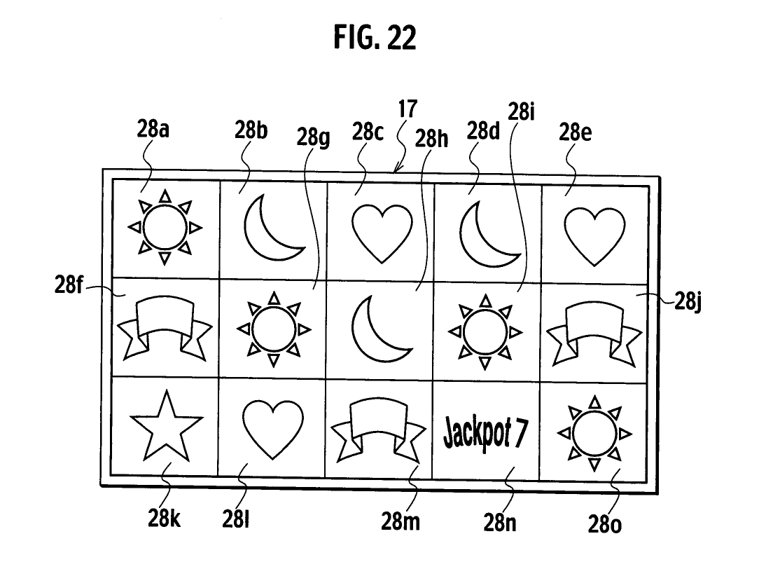

Then, the above-described processing is repeated again and a payout based on the number of linked “STAR” symbols, two, and the number of linked “MOON” symbols, two, is selected and these symbols are deleted, and rearrangement is carried out again by shifting and displaying the symbols, as shown in FIG. 21. In the symbol matrix, shown in FIG. 22, formed as a result of the rearrangement, no symbol link has been achieved or no further chain reaction of combination has occurred. At this point of time, the chain reaction game is over and a corresponding payout is made. In the example described above, the number of credits to be paid out based on the number of linked “SMILE” symbols, three, and the number of linked “RIBBON” symbols, five, is “40”, that based on the number of linked “STAR” symbols, two, and the number of linked “MOON” symbols, two, is “15”, which has occurred twice, and the chain reaction of combination has occurred three times, then, a total of “(40+15+15)×4=280” credits is paid out.

As described above, in the chain reaction game, a payout results from a combination achieved by an achieved symbol link. Then, the achieved combination is deleted from the display areas and the symbol matrix is rearranged so that the vacant display areas are filled with symbols. Further, when a symbol link is achieved again in the rearranged symbol matrix, that is, when a chain reaction of combination occurs, a corresponding payout is further given. In other words, a payout can result from conditions different from those of the conventional activated line. In addition, in the present embodiment, it is possible to cause a player to have a sense of higher expectation by providing a new entertainment property that a payout is added or multiplied to the “payout to the player” as long as the symbol link and the chain reaction of combination continue to occur.

The payout table and the odds table in FIG. 5 and FIG. 6 described in the present embodiment are mere examples, not limiting. Further, the display examples of the chain reaction game using FIG. 14 to FIG. 22 are also mere examples, not limiting.

FIG. 11 is a flow chart showing the scroll control processing of symbols shown in step S17 in FIG. 9. This processing is one performed when the main CPU 41 executes the stop symbol determination program stored in the RAM 43.

First, the main CPU 41 selects a random number value corresponding to each of the display areas 28 from among the numerical value range of 0 to 255 by executing the random number generation program included in the stop symbol determination program.

Next, the main CPU 41 refers to the symbol weighted data in accordance with the payout rate setting data output from the GAL 54 and stored in the RAM 43 and determines code numbers (refer to FIG. 3) of the symbols to be stopped and displayed in each of the display areas 28 with a total of 15 squares, that is, 5×3 squares (step S52). In addition, the main CPU 41 determines a winning combination by determining a code number of each of the display areas 28. For example, in the combination shown in FIG. 4, if the code numbers of the symbols to be displayed in the display areas 28f to 28j among the display areas 28 (28a to 28o) are determined as “03”, “03”, “03”, and “03”, it means that the main CPU 41 has determined the winning combination as that of the “MOON” symbols and the number of credits to be paid out is 10.

FIG. 12 is a flow chart showing the scroll processing of symbols shown in step S18 in FIG. 9. This processing is processing performed between the main CPU 41 and the sub CPU 61.

First, the main CPU 41 transmits a start signal to the effect that the scroll of symbols is started in the display areas 28 of the liquid crystal display 17 to the sub CPU 61 (step S61). When receiving the start signal from the main CPU 41, the sub CPU 61 outputs a symbol scroll direction to the VDP 46 and the VDP 46 reads image data of the symbols stored in the image data ROM 47 and scrolls the symbols in the five columns of the display areas 28 of the liquid crystal display 17 (step S71). Due to this, the scroll of symbols starts in the five columns of the display areas 28.

After transmitting the start signal to the sub CPU 61 in step 61, the main CPU 41 executes the effect when scrolling symbols (step S62). In this processing, images are displayed on the lower image display panel 16, voices are output from the speaker 29, etc., over the period (for example, three seconds) specified in accordance with the result etc. of the stop symbol determination processing (step S17 in FIG. 9).

Next, the main CPU 41 determines whether or not it is a timing of the direction to stop the scroll (step S63 in FIG. 12).

When it is determined not to be the timing of the direction to stop the scroll in the processing in step S63, the processing is returned to step S63 and the effect when scrolling is continued. On the other hand, when it is determined to be the timing of the direction to stop the scroll in the processing in step S63, the main CPU 41 transmits the code numbers of the symbols stored in the RAM 43 to the sub CPU 61 (step S64). When receiving the code numbers of the symbols from the main CPU 41, the sub CPU 61 determines the stop positions of the scroll corresponding to the code numbers (step S72).

After that, the scroll stop processing is performed and the symbols stop and are displayed in each of the display areas 28 (step S73). In addition, the display processing of effect images by the main CPU 41 is terminated (step S65).

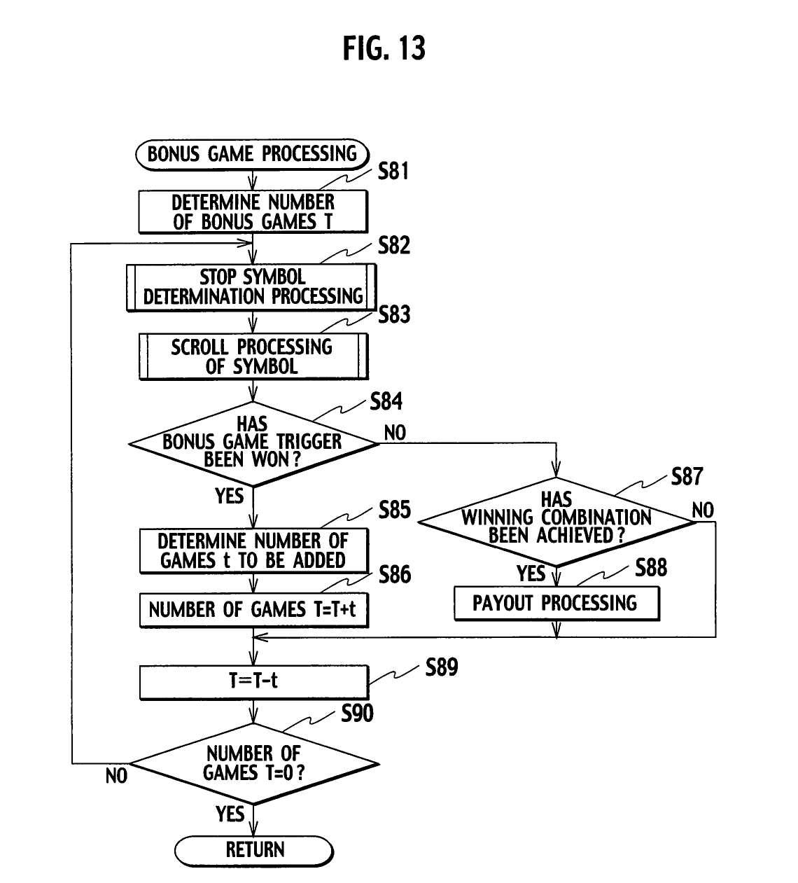

FIG. 13 is a flow chart showing the bonus game processing shown in step S22 in FIG. 9. In the bonus game processing, first, the main CPU 41 determines the number of times T the bonus game is to be executed from among 10 to 25 games based on the random number values obtained by executing the random number generation program included in the stop symbol determination program stored in the RAM 43 (step S81). The main CPU 41 stores the data of the determined number of games T of the bonus game in the RAM 43.

Next, the main CPU 41 performs the stop symbol determination processing (step S82) and the scroll processing of symbols (step S83). The processing in step S82 is processing substantially the same as that described using FIG. 10. In addition, the processing in step S83 is processing substantially the same as that described using FIG. 11. The processing is already described and therefore its described is omitted here.

Next, in FIG. 12, the main CPU 41 determines whether or not the bonus game trigger has been achieved, that is, whether or not the combination of the “SMILE” symbols has stopped on the payline activated in each of the display areas 28 (step S84). When it is determined that the bonus game trigger has been achieved (YES in step S84), the number of repetition times t of the bonus game is newly determined (step S85) and the determined number of repetition times t is added to the current number of games of the bonus game T (step S86). Due to this, if the bonus game is won again during the bonus game, the number of remaining times of the bonus game increases.

When the bonus game trigger has not been achieved, the main CPU 41 determines whether or not a winning combination has been achieved (step S87). When it is determined that a winning combination has been achieved (YES in step S87), the main CPU 41 pays out coins in accordance with the number of inserted coins and the winning combination (step S88). On this occasion, the payout is made based on the payout table shown in FIG. 5.

When the processing in step S86 or S88 is executed, or when it is determined that any winning combination has not been achieved (it is determined to be losing) in step S87, the main CPU 61 reads the number of games T stored in the RAM 43 and subtracts one from the read number of games T. Then, the number of games T after the subtraction is stored again in the RAM 43 (step S89).

Next, the main CPU 41 determines whether or not the number of the bonus games T has reached the number of times determined in step S81 (step S90). Specifically, the main CPU 41 determines whether or not the number of games T stored in the RAM 43 has reached zero and when the number of games T is not zero, that is, it is determined that the number of execution times of the bonus game has not reached the number of times determined in step S81, the processing is returned to step S82 and the above-described processing is repeated.

On the other hand, when the number of games T is zero, that is, when it is determined that the number of execution times of the bonus game has reached the number of times T determined in step S81, the processing is terminated. In this manner, the bonus game is performed.

As described above, in the slot machine and the playing method according to the present embodiment, when a prescribed combination of symbols, such as “SMILE” etc. set in the payout table shown in FIG. 4, has stopped in the display areas 28f to 28j, a corresponding payout is made.

As described above, the slot machine in an embodiment of the present invention has been described, however, the specific examples are only illustrative, not limiting the present invention and the specific configuration of each means etc. can be adequately modified in design. In addition, the effects described in the embodiments of the present invention are only enumerated from most preferred ones resulting from the present invention and the effects of the present invention are not limited by those described in the embodiments of the present invention.

What is claimed is:

1. A slot machine comprising:
a display on which display areas are formed in a matrix form, the display areas scrolling symbol columns in which a plurality of symbols having mutually different attributes is arranged, and which arranges a symbol matrix of symbols displayed in each of the display areas when the scroll stops; and
a controller operable to:
after scrolling the symbol columns arranged on the display in one direction, in order to rearrange them as a new symbol matrix,
(a) select and determine symbols arranged in the symbol matrix from among the plurality of symbols having the different attributes and
(b) stop scroll state with the determined symbols;
when the symbols are arranged on the display and if there exist a prescribed number or more of neighboring symbols having the same attribute,
(c) delete the prescribed number or more of neighboring symbols and
(d) shift the symbols arranged as the symbol matrix in a prescribed direction to rearrange them in the vacant areas from which the symbols have been deleted; and
when the prescribed number or more of neighboring symbols form a combination accompanied by an award, and/or when the symbols rearranged as the symbol matrix form a combination accompanied by the award,
(e) provide the award in accordance with each combination.

2. The slot machine according to claim 1, further comprising a memory configured to store the combination accompanied by the award and the award corresponding to the combination, wherein:
the controller determines whether the symbols stopped and the symbols rearranged as the symbol matrix form a combination accompanied by the award stored in the memory; and
the controller, when the symbols stopped and the symbols rearranged as the symbol matrix form the combination accompanied by the award, provides the award in accordance with the combination.

3. The slot machine according to claim 1, further comprising:
a memory configured to store the combination accompanied by the award and the award corresponding to the combination; and
a counter configured to count, when the symbols rearranged by the controller successively form the combination accompanied by the award, the number of successive times the combination accompanied by the award is formed, wherein:
the controller is further operable to:
determine whether the symbols stopped and the symbols rearranged as the symbol matrix form the combination accompanied by the award stored in the memory; and
when the symbols stopped and the symbols rearranged as the symbol matrix form a combination accompanied by the award and when the symbols successively form a combination accompanied by the award in the rearrangement, provide the award in accordance with the combination and the number of successive times of the combination counted by the counter.

4. A slot machine comprising:
a display on which display areas are formed in a matrix form, the display areas scrolling symbol columns including a plurality of arranged symbols having mutually different attributes, and which arranges a symbol matrix of symbols stopped and displayed in each of the display areas;
a memory configured to store a combination accompanied by an award and the award corresponding to the combination; and
a controller operable to:
after scrolling the symbol columns arranged on the display in one direction, in order to rearrange them as a new symbol matrix,
(a) select and determine symbols to be arranged in the symbol matrix from among the plurality of symbols having different attributes and
(b) stop scroll state with the determined symbols;
when the symbols are arranged on the display and if there exist a prescribed number or more of neighboring symbols having the same attribute,
(c) delete the prescribed number or more of neighboring symbols and
(d) shift the undeleted symbols arranged as the symbol matrix in a prescribed direction to vacant areas where the symbols have been deleted;
(e) determine whether the symbols stopped and the symbols rearranged as the symbol matrix form the combination accompanied by the award stored in the memory; and
when the prescribed number or more of neighboring symbols form the combination accompanied by the award, and/or when the symbols rearranged as the symbol matrix form the combination accompanied by the award,
(f) provide the award in accordance with each combination.

5. The slot machine according to claim 4, further comprising:
a counter configured to count, when the rearranged symbols successively form the combination accompanied by the award, the number of successive times the combination accompanied by the award is formed, wherein:
when the symbols stopped and the symbols rearranged as the symbol matrix form the combination accompanied by the award and when the symbols successively form the combination accompanied by the award in the rearrangement, the controller is further operable to provide the award in accordance with the combination and the number of successive times of the combination counted by the counter.

6. A slot machine comprising:
a display on which display areas are formed in a matrix form, the display areas scrolling symbol columns including a plurality of arranged symbols having mutually different attributes, and which arranges a symbol matrix of symbols stopped and displayed in each of the display areas;
a memory configured to store a combination of the symbols accompanied by an award and the award corresponding to the combination;
a counter configured to count, when the rearranged symbols successively form the combination accompanied by the award, the number of successive times the combination accompanied by the award is formed: and
a controller operable to:
after scrolling the symbol columns arranged on the display in one direction, in order to rearrange them as a new symbol matrix,
(a) select and determine symbols to be arranged in the symbol matrix from among the plurality of symbols having the different attributes and
(b) stop scroll state with the determined symbols;
when the symbols are arranged on the display and if there exist a prescribed number or more of neighboring symbols having the same attribute,
(c) delete the prescribed number or more of neighboring symbols and
(d) shift the undeleted symbols arranged as the symbol matrix in a prescribed direction to vacant areas where the symbols have been deleted;
(e) determine whether the symbols stopped and the symbols rearranged as the symbol matrix form the combination accompanied by the award stored in the memory; and
when the symbols stopped and the symbols rearranged as the symbol matrix form the combination accompanied by the award and when the symbols successively form the combination accompanied by the award in the rearrangement,
(f) provide the award in accordance with the combination and the number of successive times of the combination counted by the counter.

7. A playing method of a slot machine, comprising:
a first arrangement step of, in display areas arranged on a display in a matrix form and that scroll symbol columns including a plurality of arranged symbols having mutually different attributes, after scrolling the symbol columns in one direction, selecting and determining symbols to be arranged as the symbol matrix from among the plurality of symbols having the different attributes, stopping scroll state with the determined symbols, and rearranging them as a new symbol matrix;
a second arrangement step of, when the symbols are arranged on the display as the symbol matrix and if there exist a prescribed number or more of neighboring symbols having the same attribute, deleting the prescribed number or more of neighboring symbols and shifting the undeleted symbols arranged as the symbol matrix in a prescribed direction to vacant areas where the symbols have been deleted; and
an award step of, when the prescribed number or more of neighboring symbols form a combination in the first arrangement step, and/or when the symbols rearranged in the second arrangement step form a combination accompanied by an award, providing the award in accordance with each combination.

8. The playing method of a slot machine according to claim 7, further comprising:
a determination step of determining whether or not the symbols stopped in the first arrangement step and the symbols rearranged in the second arrangement step form the combination accompanied by the award stored in a memory configured to store the combination accompanied by the award and the award corresponding to the combination, wherein:
when it is determined in the determination step that the symbols stopped in the first arrangement step and the symbols rearranged in the second arrangement step form the combination accompanied by the award, the award is provided in accordance with the combination in the award step.

9. The playing method of a slot machine according to claim 7, further comprising:
a determination step of determining whether the symbols stopped in the first arrangement step and the symbols rearranged in the second arrangement step form the combination accompanied by the award stored in a memory configured to store the combination accompanied by the award and the award corresponding to the combination; and
a count step of, when the symbols successively form the combination accompanied by the award by the rearrangement in the second arrangement step, counting the number of successive times the combination accompanied by the award is formed,
wherein:
when it is determined in the determination step that the symbols stopped in the first arrangement step and the symbols rearranged in the second arrangement step form the combination accompanied by the award and it is determined that the symbols successively form the combination accompanied by the award by the rearrangement in the second arrangement step, the award is provided in accordance with the combination and the number of successive times of the combination counted by the counter in the award step.

10. A playing method of a slot machine, comprising:
a first arrangement step of, in display areas arranged on a display in a matrix form and that scroll symbol columns including a plurality of arranged symbols having mutually different attributes, after scrolling the symbol columns in one direction, selecting and determining symbols to be arranged as the symbol matrix from among the plurality of symbols having the different attributes, stopping scroll state with the determined symbols, and rearranging them as a new symbol matrix;
a second arrangement step of, when the symbols are arranged on the display and if there exist a prescribed number or more of neighboring symbols having the same attribute, deleting the prescribed number or more of neighboring symbols and shifting the undeleted symbols arranged as the symbol matrix in a prescribed direction to vacant areas where the symbols have been deleted;
a determination step of determining whether the symbols stopped in the first arrangement step and the symbols rearranged in the second arrangement step form a combination accompanied by an award stored in a memory configured to store the combination accompanied by the award and the award corresponding to the combination; and
an award step of, when the prescribed number or more of neighboring symbols form the combination accompanied by the award in the first arrangement step and/or when the symbols rearranged in the second arrangement step form the combination accompanied by the award, providing the award in accordance with each combination.

11. The playing method of a slot machine according to claim 10, further comprising:
a count step of, when the symbols successively form the combination accompanied by the award by the rearrangement in the second arrangement step, counting the number of successive times the combination accompanied by the award is formed, wherein:
when it is determined in the determination step that the symbols stopped in the first arrangement step and the symbols rearranged in the second arrangement step form the combination accompanied by the award and it is determined that the symbols successively form the combination accompanied by the award by the rearrangement in the second arrangement step, the award is provided in accordance with the combination and the number of successive times of the combination counted by the counter in the award step.

12. A playing method of a slot machine, comprising:
a first arrangement step of, in display areas arranged on a display in a matrix form and that scroll symbol columns including a plurality of arranged symbols having mutually different attributes, after scrolling the symbol columns in one direction, selecting and determining symbols to be arranged as the symbol matrix from among the plurality of symbols having different attributes, stopping scroll state with the determined symbols, and rearranging them as a new symbol matrix;
a second arrangement step of, when the symbols are arranged on the display and if there exist a prescribed number or more of neighboring symbols having the same attribute, deleting the prescribed number or more of neighboring symbols and shifting the undeleted symbols arranged as the symbol matrix in a prescribed direction to vacant areas where the symbols have been deleted;
a determination step of determining whether the symbols stopped in the first arrangement step and the symbols rearranged in the second arrangement step form a combination accompanied by an award stored in a memory configured to store the combination accompanied by the award and the award corresponding to the combination;
a count step of, when the symbols successively form the combination accompanied by the award by the rearrangement in the second arrangement step, counting the number of successive times the combination accompanied by the award is formed; and
an award step of, when it is determined in the determination step that the symbols stopped in the first arrangement step and the symbols rearranged in the second arrangement step form the combination accompanied by the award and it is determined that the symbols successively form the combination accompanied by the award by the rearrangement in the second arrangement step, providing the award in accordance with the combination and the number of successive times of the combination counted by the counter.
